(19) United States
(12) Patent Application Publication
(10) Pub. No.: US 2021/0034967 A1
(43) Pub. Date: Feb. 4, 2021

(54) ENVIRONMENT CONTROLLER AND METHODS FOR VALIDATING AN ESTIMATED NUMBER OF PERSONS PRESENT IN AN AREA

(71) Applicant: Distech Controls Inc., Brossard (CA)

(72) Inventors: Patrice SOUCY, Marieville (CA); Francois GERVAIS, Lachine (CA)

(21) Appl. No.: 16/697,877

(22) Filed: Nov. 27, 2019

Related U.S. Application Data
(60) Provisional application No. 62/881,563, filed on Aug. 1, 2019.

(51) Int. Cl. G06N 3/08; G06N 3/04; F24F 11/64; F24F 11/49

(52) U.S. Cl. CPC G06N 3/08; G06N 3/04; F24F 2110/10; F24F 11/49; F24F 11/64

(57) ABSTRACT

Methods and environment controller for validating an estimated number of persons present in an area. The controller determines a temperature measurement in the area, a carbon dioxide (CO2) level measurement in the area, a humidity level measurement in the area, and the estimated number of persons present in the area based on data generated by an occupancy sensor. The controller executes a neural network inference engine for generating outputs based on inputs, using a predictive model comprising weights of a neural network. The inputs include the temperature, CO2 level and humidity level measurements, and the estimated number of persons. The outputs include an inferred temperature, an inferred CO2 level, an inferred humidity level, and an inferred number of persons. The controller applies a validation algorithm to the inputs and outputs of the neural network inference engine, to determine if the estimated number of persons is accurate or not.

### CROSS-REFERENCE TO RELATED APPLICATIONS

This Application claims priority to U.S. Provisional Patent Application No. 62/881,563, filed Aug. 1, 2019, titled “ENVIRONMENT CONTROLLER AND METHOD FOR VALIDATING AN ESTIMATED NUMBER OF PERSONS PRESENT IN AN AREA,” the disclosure of which is incorporated herein by reference in its entirety for all purposes.

### TECHNICAL FIELD

The present disclosure relates to the field of building automation, and more precisely to the control of environmental conditions in an area of a building. More specifically, the present disclosure presents an environment controller and methods using a neural network for validating an estimated number of persons present in an area determined through an occupancy sensor.

### BACKGROUND

Systems for controlling environmental conditions, for example in buildings, are becoming increasingly sophisticated. An environment control system may at once control heating and cooling, monitor air quality, detect hazardous conditions such as fire, carbon monoxide release, intrusion, and the like. Such environment control systems generally include at least one environment controller, which receives measured environmental values, generally from sensors, and in turn determines set-points or command parameters to be sent to controlled appliances.

The environment controller and the devices under its control (sensors, controlled appliances, etc.) are generally referred to as Environment Control Devices (ECDs). An ECD comprises processing capabilities for processing data received via one or more communication interface and/or generating data transmitted via the one or more communication interface.

For example, the environment controller controls a heating, ventilating, and/or air-conditioning (HVAC) appliance, in order to regulate the temperature, humidity level and CO2 level in an area of a building. The temperature and CO2 level in the area depend on the number of persons present in the area. If the number of persons present in the area increases, the temperature and CO2 level in the area are likely to increase. If the number of persons present in the area decreases, the temperature and CO2 level in the area are likely to decrease.

Occupancy sensors, such as cameras or infrared beam sensors, can be deployed to keep track of the number of persons present in an area (e.g. in a room). The evolution of the number of persons present in the area is used by the environment controller for smoothly adjusting the operations of controlled appliances (e.g. an HVAC appliance), to maintain a safe and comfortable environment for the persons present in the area.

However, the estimation of the number of persons present in the area based on data generated by an occupancy sensor may be inaccurate. In this case, the environment controller takes adjustment decisions for the environmental control of the area, based on an erroneous estimation of the number of persons present in the area. This situation is prejudicial to the occupants of the area, in terms of comfort, and possibly also health or security.

Therefore, there is a need for an environment controller and methods using a neural network for validating an estimated number of persons present in an area determined through an occupancy sensor.

### SUMMARY

According to a first aspect, the present disclosure relates to an environment controller. The environment controller comprises memory for storing a predictive model comprising weights of a neural network. The environment controller comprises a processing unit comprising one or more processor. The processing unit determines a temperature measurement in an area, a carbon dioxide (CO2) level measurement in the area, and a humidity level measurement in the area. The processing unit also determines an estimated number of persons present in the area based on data generated by an occupancy sensor. The processing unit executes a neural network inference engine using the predictive model for generating outputs based on inputs. The inputs include the temperature measurement in the area, the CO2 level measurement in the area, the humidity level measurement in the area and the estimated number of persons present in the area. The outputs include an inferred temperature, an inferred CO2 level, an inferred humidity level and an inferred number of persons. The processing unit further applies a validation algorithm to the inputs and the outputs of the neural network inference engine, to determine if the estimated number of persons present in the area is accurate or not.

According to a second aspect, the present disclosure relates to a method for validating an estimated number of persons present in an area determined through an occupancy sensor. The method comprises storing a predictive model comprising weights of a neural network in a memory of a computing device. The method comprises determining, by a processing unit of the computing device, a temperature measurement in the area, a carbon dioxide (CO2) level measurement in the area, and a humidity level measurement in the area. The method also comprises determining, by the processing unit of the computing device, the estimated number of persons present in the area based on data generated by the occupancy sensor. The method comprises executing, by the processing unit of the computing device, a neural network inference engine. The neural network inference engine uses the predictive model for generating outputs based on inputs. The inputs include the temperature measurement in the area, the CO2 level measurement in the area, the humidity level measurement in the area and the estimated number of persons present in the area. The outputs include an inferred temperature, an inferred CO2 level, an inferred humidity level and an inferred number of persons. The method comprises applying, by the processing unit of the computing device, a validation algorithm to the inputs and the outputs of the neural network inference engine, to determine if the estimated number of persons present in the area is accurate or not.

According to a third aspect, the present disclosure relates to a method for training a neural network to validate an estimation of a number of persons present in an area. The method comprises initializing, by a processing unit of a computing device, a predictive model comprising weights of the neural network. The method comprises generating, by the processing unit of the computing device, a set of inputs. The set of inputs includes a reference temperature, a reference carbon dioxide (CO2) level, a reference humidity level and a reference number of persons. The method comprises executing, by the processing unit of the computing device, a neural network training engine using the predictive model for generating outputs based on the inputs. The outputs include an inferred temperature, an inferred CO2 level, an inferred humidity level and an inferred number of persons. The method comprises adjusting, by the processing unit of the computing device, the weights of the neural network to minimize a difference between the outputs and the inputs.

According to a fourth aspect, the present disclosure relates to an environment controller. The environment controller comprises memory for storing a predictive model comprising weights of a neural network. The environment controller comprises a processing unit comprising one or more processor. The processing unit determines a plurality of consecutive temperature measurements in an area. The processing unit determines a plurality of consecutive carbon dioxide (CO2) level measurements in the area. The processing unit determines a plurality of consecutive humidity level measurements in the area. The processing unit determines a plurality of consecutive estimated numbers of persons present in the area based on data generated by an occupancy sensor. The processing unit executes a neural network inference engine using the predictive model for generating outputs based on inputs. The inputs comprise the plurality of consecutive temperature measurements in the area, the plurality of consecutive CO2 level measurements in the area, the plurality of consecutive humidity level measurements in the area and the plurality of consecutive estimated numbers of persons present in the area. The outputs comprise an inferred temperature, an inferred CO2 level, an inferred humidity level and an inferred number of persons. The processing unit applies a validation algorithm to the inputs and the outputs of the neural network inference engine to determine if a candidate number of persons present in the area is accurate or not. The candidate number of persons present in the area consists of the last value of the plurality of consecutive estimated numbers of persons present in the area.

According to a fifth aspect, the present disclosure relates to a method for validating a candidate number of persons present in an area determined through an occupancy sensor. The method comprises storing a predictive model comprising weights of a neural network in a memory of a computing device. The method comprises determining, by a processing unit of the computing device, a plurality of consecutive temperature measurements in the area. The method comprises determining, by the processing unit of the computing device, a plurality of consecutive carbon dioxide (CO2) level measurements in the area. The method comprises determining, by the processing unit of the computing device, a plurality of consecutive humidity level measurements in the area, The method comprises determining, by the processing unit of the computing device, a plurality of consecutive estimated numbers of persons present in the area based on data generated by the occupancy sensor. The method comprises executing, by the processing unit of the computing device, a neural network inference engine using the predictive model for generating outputs based on inputs. The inputs comprise the plurality of consecutive temperature measurements in the area, the plurality of consecutive CO2 level measurements in the area, the plurality of consecutive humidity level measurements in the area and the plurality of consecutive estimated numbers of persons present in the area. The outputs comprise an inferred temperature, an inferred CO2 level, an inferred humidity level and an inferred number of persons. The method comprises applying, by the processing unit of the computing device, a validation algorithm to the inputs and the outputs of the neural network inference engine to determine if the candidate number of persons present in the area is accurate or not. The candidate number of persons present in the area consists of the last value of the plurality of consecutive estimated numbers of persons present in the area.

According to a sixth aspect, the present disclosure relates to a method for training a neural network to validate an estimation of a number of persons present in an area. The method comprises initializing, by a processing unit of a computing device, a predictive model comprising weights of the neural network. The method comprises generating, by the processing unit of the computing device, a set of inputs. The set of inputs comprises a plurality of consecutive temperatures, a plurality of consecutive carbon dioxide (CO2) levels, a plurality of consecutive humidity levels and a plurality of consecutive numbers of persons. The method comprises executing, by the processing unit of the computing device, a neural network training engine using the predictive model for generating outputs based on the inputs. The outputs comprise an inferred temperature, an inferred CO2 level, an inferred humidity level and an inferred number of persons. The method comprises adjusting, by the processing unit of the computing device, the weights of the neural network to minimize a difference between the outputs and the inputs.

### BRIEF DESCRIPTION OF THE DRAWINGS

Embodiments of the disclosure will be described by way of example only with reference to the accompanying drawings, in which:

FIG. 1 illustrates an environment control system comprising an environment controller;

FIGS. 2A and 2B illustrate a method performed by the environment controller of FIG. 1 for validating an estimated number of persons present in an area determined through an occupancy sensor;

FIG. 3 is a schematic representation of a neural network inference engine executed by the environment controller of FIG. 1 according to the method of FIGS. 2A-B;

FIG. 4 is a detailed representation of a neural network implemented by the neural network inference engine of FIG. 3;

FIG. 5 represents an environment control system where several environment controllers implementing the method illustrated in FIGS. 2A-B are deployed;

FIG. 6 is a detailed representation of the training server illustrated in in FIG. 1;

FIG. 7 illustrates a method performed by the training server of FIG. 6 for training a neural network to validate an estimation of a number of persons;

FIGS. 8A and 8B illustrate another method performed by the environment controller of FIG. 1 for validating an estimated number of persons present in an area determined through an occupancy sensor;

FIG. 9 is a schematic representation of a neural network inference engine executed by the environment controller of FIG. 1 according to the method of FIGS. 8A-B;

FIG. 10 illustrates another method performed by the training server of FIG. 6 for training a neural network to validate an estimation of a number of persons; and

FIGS. 11A and 11B are a detailed representations of a neural network implemented by the neural network inference engine of FIG. 9.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to environment control systems for buildings. More particularly, the present disclosure aims at providing solutions for determining if an estimated number of persons present in an area is accurate or not. The estimated number of persons present in the area is determined based on data generated by an occupancy sensor. The validation of the estimated number of persons present in the area relies on the usage of a neural network.

The following terminology is used throughout the present specification:
Environment: condition(s) (temperature, pressure, oxygen level, light level, security, etc.) prevailing in a controlled area or place, such as for example in a building.
Environment control system: a set of components which collaborate for monitoring and controlling an environment.
Environmental data: any data (e.g. information, commands) related to an environment that may be exchanged between components of an environment control system.
Environment control device (ECD): generic name for a component of an environment control system. An ECD may consist of an environment controller, a sensor, a controlled appliance, etc.
Environment controller: device capable of receiving information related to an environment and sending commands based on such information.
Environmental characteristic: measurable, quantifiable or verifiable property of an environment (a building). The environmental characteristic comprises any of the following: temperature, pressure, humidity, lighting, CO2, flow, radiation, water level, speed, sound; a variation of at least one of the following, temperature, pressure, humidity and lighting, CO2 levels, flows, radiations, water levels, speed, sound levels, etc., and/or a combination thereof.
Environmental characteristic value: numerical, qualitative or verifiable representation of an environmental characteristic.
Sensor: device that detects an environmental characteristic and provides a numerical, quantitative or verifiable representation thereof. The numerical, quantitative or verifiable representation may be sent to an environment controller.
Controlled appliance: device that receives a command and executes the command. The command may be received from an environment controller.
Environmental state: a current condition of an environment based on an environmental characteristic, each environmental state may comprise a range of values or verifiable representation for the corresponding environmental characteristic.
VAV appliance: a Variable Air Volume appliance is a type of heating, ventilating, and/or air-conditioning (HVAC) system. By contrast to a Constant Air Volume (CAV) appliance, which supplies a constant airflow at a variable temperature, a VAV appliance varies the airflow at a constant temperature.
Area of a building: the expression ‘area of a building’ is used throughout the present specification to refer to the interior of a whole building or a portion of the interior of the building such as, without limitation: a floor, a room, an aisle, etc.

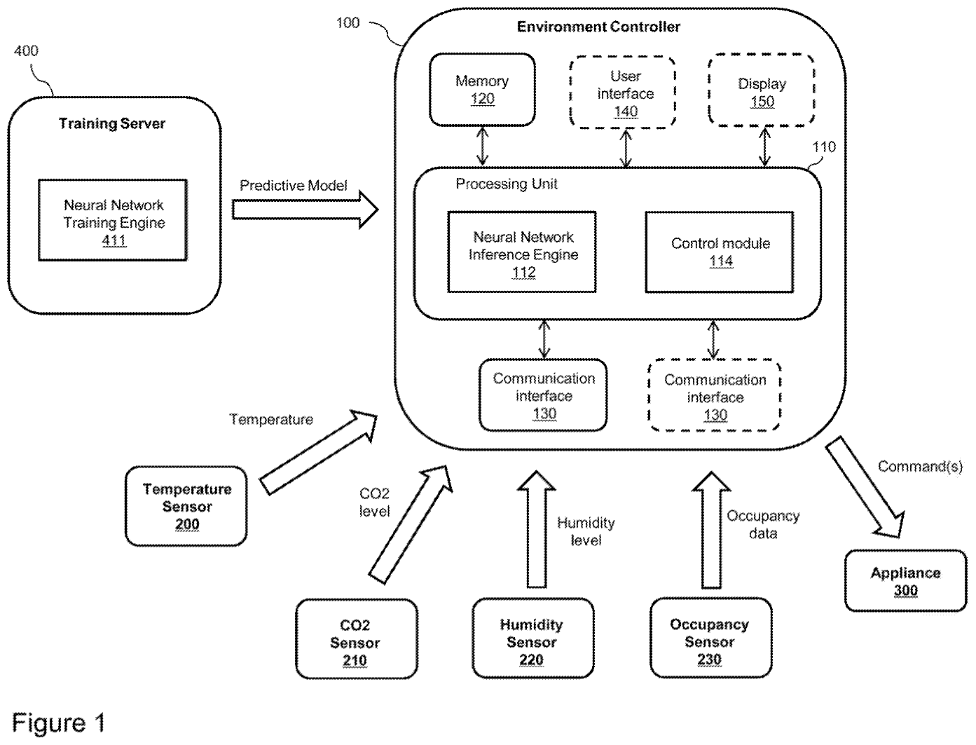

Referring now to FIG. 1, an environment control system where an environment controller 100 exchanges data with other environment control devices (ECDs) is illustrated. The environment controller 100 is responsible for controlling the environment of an area of a building. The environment controller 100 receives from sensors (e.g. 200, 210 and 220) environmental characteristic values measured by the sensors. The environment controller 100 generates commands based on the received environmental characteristic values. The generated commands are transmitted to controlled appliances 300 (to control the operations of the controlled appliances 300).

The area under the control of the environment controller 100 is not represented in the Figures for simplification purposes. As mentioned previously, the area may consist of a room, a floor, an aisle, etc. However, any type of area located inside any type of building is considered being within the scope of the present disclosure.

Examples of sensors include: a temperature sensor 200 for measuring a temperature in the area and transmitting the measured temperature to the environment controller 100, a CO2 sensor 210 for measuring a CO2 level in the area and transmitting the measured CO2 level to the environment controller 100, a humidity sensor 220 for measuring a humidity level in the area and transmitting the measured humidity level to the environment controller 100, a lighting sensor (not represented in the Figures) for measuring a light level in the area and transmitting the measured light level to the environment controller 100, etc.

Another example of sensor consists of an occupancy sensor 230 for generating occupancy data for the area, and transmitting the determined occupancy data to the environment controller 100. Examples of occupancy sensors 230 will be provided later in the description. The occupancy data generated by the occupancy sensor 230 may consist in the number of persons present in the area. Alternatively, the occupancy data generated by the occupancy sensor 230 may consist of data which need to be further processed to determine the number of persons present in the area.

Each environmental characteristic value measured by a sensor may consist of either a single value (e.g. the current CO2 level measured by the CO2 sensor 210 is 405 parts per million), or a range of values (e.g. the current CO2 level measured by the CO2 sensor 210 is in the range of 400 to 410 parts per million).

In a first implementation, a single sensor (e.g. CO2 sensor 210) measures a given type of environmental characteristic value (e.g. CO2 level) for the whole area. In a second implementation, the area is divided into a plurality of zones, and a plurality of sensors (e.g. temperature sensors 200) measures the given type of environmental characteristic value (e.g. temperature) in the corresponding plurality of zones. In the second implementation, the environment controller 100 calculates an average environmental characteristic value in the area (e.g. an average temperature in the area) based on the environmental characteristic values transmitted by the plurality of sensors (e.g. temperature sensors 200) respectively located in the plurality of zones of the area.

Additional sensor(s) may be deployed outside of the area and report their measurement(s) to the environment controller 100. For example, the area is a room of a building. An external temperature sensor measures an external temperature outside the building and transmits the measured external temperature to the environment controller 100. Similarly, an external humidity sensor measures an external humidity level outside the building and transmits the measured external humidity level to the environment controller 100.

Each controlled appliance 300 comprises at least one actuation module, to control the operations of the controlled appliance 300 based on the commands received from the environment controller 100. The actuation module can be of one of the following types: mechanical, pneumatic, hydraulic, electrical, electronical, a combination thereof, etc. The commands control operations of the at least one actuation module. Although a single controlled appliance 300 is represented in FIG. 1 for simplification purposes, the environment controller 100 may be interacting with a plurality of controlled appliances 300.

An example of a controlled appliance 300 consists of a VAV appliance. Examples of commands transmitted to the VAV appliance include commands directed to one of the following: an actuation module controlling the speed of a fan, an actuation module controlling the pressure generated by a compressor, an actuation module controlling a valve defining the rate of an airflow, etc. This example is for illustration purposes only. Other types of controlled appliances 300 could be used in the context of an environment control system managed by the environment controller 100.

Details of the environment controller 100, sensors (200, 210, 220 and 230) and control appliance 300 will now be provided.

The environment controller 100 comprises a processing unit 110, memory 120, and a communication interface 130. The environment controller 100 may comprise additional components, such as another communication interface 130, a user interface 140, a display 150, etc.

The processing unit 110 comprises one or more processors (not represented in the Figures) capable of executing instructions of a computer program. Each processor may further comprise one or several cores. The processing unit 110 executes a neural network inference engine 112 and a control module 114, as will be detailed later in the description.

The memory 120 stores instructions of computer program(s) executed by the processing unit 110, data generated by the execution of the computer program(s), data received via the communication interface 130 (or another communication interface), etc. Only a single memory 120 is represented in FIG. 1, but the environment controller 100 may comprise several types of memories, including volatile memory (such as a volatile Random Access Memory (RAM), etc.) and non-volatile memory (such as a hard drive, electrically-erasable programmable read-only memory (EEPROM), flash, etc.).

The communication interface 130 allows the environment controller 100 to exchange data with remote devices (e.g. the sensors (200, 210, 220 and 230), the controlled appliance 300, etc.) over a communication network (not represented in FIG. 1 for simplification purposes). For example, the communication network is a wired communication network, such as an Ethernet network; and the communication interface 130 is adapted to support communication protocols used to exchange data over the Ethernet network. Other types of wired communication networks may also be supported by the communication interface 130. In another example, the communication network is a wireless communication network, such as a Wi-Fi network; and the communication interface 130 is adapted to support communication protocols used to exchange data over the Wi-Fi network. Other types of wireless communication network may also be supported by the communication interface 130, such as a wireless mesh network, Bluetooth®, Bluetooth® Low Energy (BLE), etc. In still another example, the environment controller 100 comprises two communication interfaces 130. The environment controller 100 communicates with the sensors (200, 210, 220 and 230) and the controlled appliance 300 via a first communication interface 130 (e.g. a Wi-Fi interface); and communicates with other devices (e.g. a training server 400) via a second communication interface 130 (e.g. an Ethernet interface). Each communication interface 130 usually comprises a combination of hardware and software executed by the hardware, for implementing the communication functionalities of the communication interface 130.

A detailed representation of the components of the sensors (e.g. temperature sensor 200) is not provided in FIG. 1 for simplification purposes. The sensor comprises at least one sensing module for detecting an environmental characteristic (e.g. temperature). The sensor further comprises a communication interface for transmitting to the environment controller 100 an environmental characteristic value (e.g. value of the temperature) corresponding to the detected environmental characteristic. The environmental characteristic value is transmitted over a communication network and received via the communication interface 130 of the environment controller 100. The sensor may also comprise a processing unit for generating the environmental characteristic value based on the detected environmental characteristic. Alternatively, the environmental characteristic value is directly generated by the sensing module. The other types of sensors mentioned previously (e.g. CO2 sensor 210 and humidity sensor 220) generally include the same types of components as those mentioned for the temperature sensor 200.

A detailed representation of the components of the controlled appliance 300 is not provided in FIG. 1 for simplification purposes. As mentioned previously, the controlled appliance 300 comprises at least one actuation module. The controlled appliance 300 further comprises a communication interface for receiving commands from the environment controller 100. The commands control operations of the at least one actuation module. The commands are transmitted over a communication network via the communication interface 130 of the environment controller 100. The controlled appliance 300 may also comprise a processing unit for controlling the operations of the at least one actuation module based on the received commands.

A detailed representation of the components of the training server 400 is not provided in FIG. 1 for simplification purposes. The training server 400 comprises a processing unit, memory and a communication interface. The processing unit of the training server 400 executes a neural network training engine 411.

The execution of the neural network training engine 411 generates a predictive model, which is transmitted to the environment controller 100 via the communication interface of the training server 400. The predictive model is transmitted over a communication network and received via the communication interface 130 of the environment controller 100.

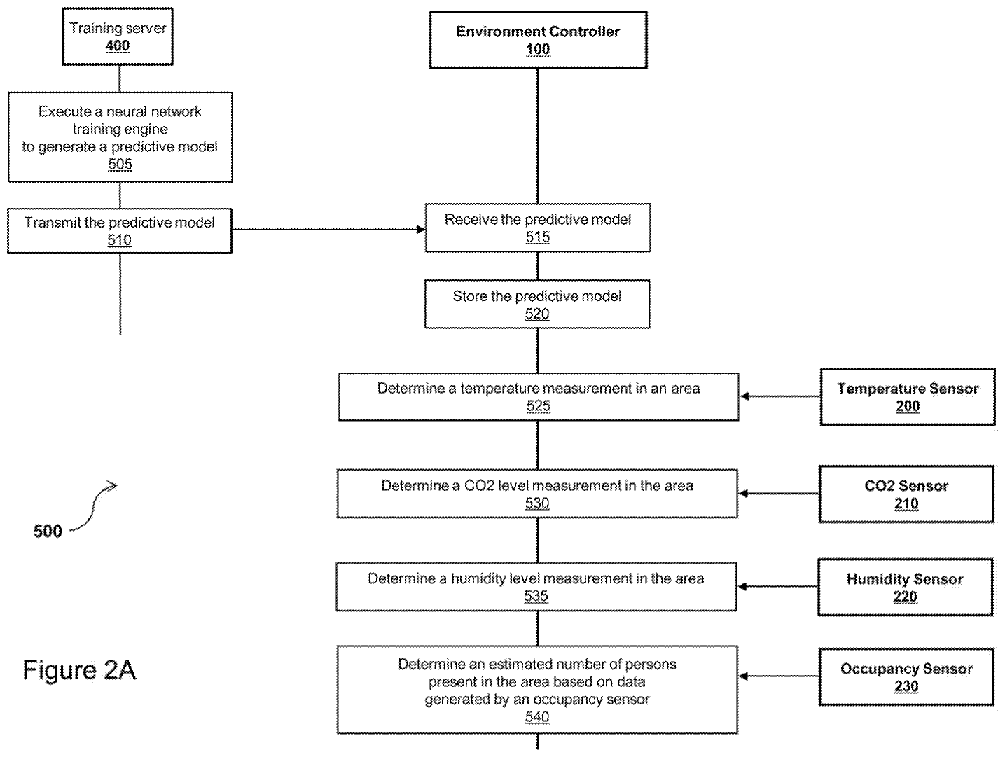

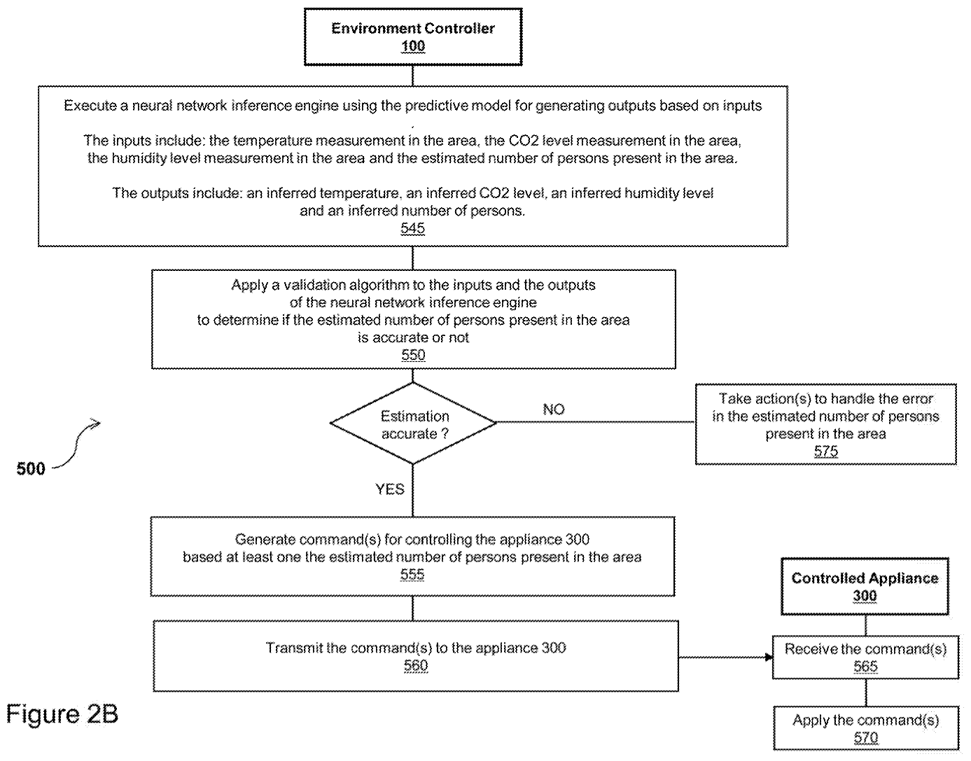

Reference is now made concurrently to FIGS. 1, 2A and 2B; where FIGS. 2A and 2B represent a method 500. At least some of the steps of the method 500 are implemented by the environment controller 100. The method 500 aims at validating an estimated number of persons present in an area, the estimated number being determined through an occupancy sensor. The present disclosure is not limited to the method 500 being implemented by the environment controller 100, but is applicable to any type of computing device capable of implementing the steps of the method 500.

A dedicated computer program has instructions for implementing at least some of the steps of the method 500. The instructions are comprised in a non-transitory computer program product (e.g. the memory 120) of the environment controller 100. The instructions provide for validating an estimated number of persons present in an area determined through an occupancy sensor, when executed by the processing unit 110 of the environment controller 100. The instructions are deliverable to the environment controller 100 via an electronically-readable media such as a storage media (e.g. CD-ROM, USB key, etc.), or via communication links (e.g. via a communication network through the communication interface 130).

The instructions of the dedicated computer program executed by the processing unit 110 implement the neural network inference engine 112 and the control module 114. The neural network inference engine 112 provides functionalities of a neural network, allowing to infer output(s) based on inputs using the predictive model, as is well known in the art. The control module 114 provides functionalities allowing the environment controller 100 to interact with and control other devices (e.g. the sensors (200, 210, 220 and 230) and the controlled appliance 300).

The method 500 comprises the step 505 of executing the neural network training engine 411 to generate the predictive model. Step 505 is performed by the processing unit of the training server 400. The predictive model comprises weights of a neural network implemented by the neural network training engine 411. This step will be further detailed later in the description.

The method 500 comprises the step 510 of transmitting the predictive model generated at step 505 to the environment controller 100, via the communication interface of the training server 400. Step 510 is performed by the processing unit of the training server 400.

The method 500 comprises the step 515 of receiving the predictive model from the training server 400, via the communication interface 130 of the environment controller 100. Step 515 is performed by the processing unit 110 of the environment controller 100.

The method 500 comprises the step 520 of storing the predictive model in the memory 120 of the environment controller 100. Step 520 is performed by the processing unit 110 of the environment controller 100.

The method 500 comprises the step 525 of determining a temperature measurement in the area. Step 525 is performed by the control module 114 executed by the processing unit 110. The temperature measurement is performed by the temperature sensor 200 (located in the area) and transmitted to the environment controller 100. Thus, step 525 consists in receiving the temperature measurement from the temperature sensor 200 via the communication interface 130 of the environment controller 100. Alternatively, functionalities of a temperature sensor are integrated to the environment controller 100. In this case, step 525 consists in receiving the temperature measurement from a temperature sensing module (not represented in FIG. 1) integrated to the environment controller 100. In still another implementation, step 525 consists in calculating the temperature in the area based on temperature measurements respectively received from a plurality of temperature sensors 200 located in the area (e.g. calculating the average of the temperature measurements received from the plurality of temperature sensors 200).

The method 500 comprises the step 530 of determining a CO2 level measurement in the area. Step 530 is performed by the control module 114 executed by the processing unit 110. The CO2 level measurement is performed by the CO2 sensor 210 (located in the area) and transmitted to the environment controller 100. Thus, step 530 consists in receiving the CO2 level measurement from the CO2 sensor 210 via the communication interface 130 of the environment controller 100. Alternatively, functionalities of a CO2 sensor are integrated to the environment controller 100. In this case, step 530 consists in receiving the CO2 level measurement from a CO2 sensing module (not represented in FIG. 1) integrated to the environment controller 100. In still another implementation, step 525 consists in calculating the CO2 level in the area based on CO2 level measurements respectively received from a plurality of CO2 sensors 210 located in the area (e.g. calculating the average of the CO2 level measurements received from the plurality of CO2 sensors 210).

The method 500 comprises the step 535 of determining a humidity level measurement in the area. Step 535 is performed by the control module 114 executed by the processing unit 110. The humidity level measurement is performed by the humidity sensor 220 (located in the area) and transmitted to the environment controller 100. Thus, step 535 consists in receiving the humidity level measurement from the humidity sensor 220 via the communication interface 130 of the environment controller 100. Alternatively, functionalities of a humidity sensor are integrated to the environment controller 100. In this case, step 535 consists in receiving the humidity level measurement from a humidity sensing module (not represented in FIG. 1) integrated to the environment controller 100. In still another implementation, step 530 consists in calculating the humidity level in the area based on humidity level measurements respectively received from a plurality of humidity sensors 220 located in the area (e.g. calculating the average of the humidity level measurements received from the plurality of humidity sensors 220).

The method 500 comprises the step 540 of determining an estimated number of persons present in the area based on data generated by the occupancy sensor 230. Step 540 is performed by the control module 114 executed by the processing unit 110. The data generated by the occupancy sensor 230 are transmitted to the environment controller 100, and received via the communication interface 130 of the environment controller 100. Alternatively, functionalities of an occupancy sensor are integrated to the environment controller 100. In this case, the data are generated and transmitted by an occupancy sensing module (not represented in FIG. 1) integrated to the environment controller 100.

In a first implementation, the occupancy sensor 230 has the capability to directly determine the number of persons present in the area. In this case, the data transmitted by the occupancy sensor 230 to the environment controller 100 include the number of persons present in the area. The determination made at step 540 consists in receiving the estimated number of persons present in the area via the communication interface 130 from the occupancy sensor 230.

In a second implementation, the occupancy sensor 230 does not have the capability to directly determine the number of persons present in the area. In this case, the data transmitted by the occupancy sensor 230 to the environment controller 100 need to be processed to determine the number of persons present in the area. The determination made at step 540 consists in receiving the data transmitted by the occupancy sensor 230 via the communication interface 130, and further processing the received data to determine the estimated number of persons present in the area.

A first example of occupancy sensor 230 is a visible or thermal camera. The camera takes a picture of the area and a detection software determines the number of persons present in the area based on the analysis of the picture. For example, the detection software implements a neural network trained to determine the number of persons present in the picture taken by the camera. Other types of detection software may be used, as is well known in the art.

In a first implementation, the detection software is integrated to and executed by the camera. In this case, the determination at step 540 consists in receiving the number of persons present in the area from the camera. In another implementation, the detection software is executed by the processing unit 110 of the environment controller 100. In this case, the determination at step 540 consists in receiving the picture from the camera and processing the picture with the detection software to determine the number of persons present in the area. In still another implementation, the detection software is executed by another computing device (not represented in FIG. 1). The other computing device receives the picture from the camera and processes the picture with the detection software to determine the number of persons present in the area. In this case, the determination at step 540 consists in receiving the number of persons present in the area from the other computing device.

A plurality (at least two) of cameras may be used to provide a better estimation of the number of persons present in the area. In this case, each camera takes a picture of the area, and the detection software uses the plurality of pictures taken by the plurality of cameras to determine the number of persons present in the area.

A second example of occupancy sensor 230 is an infrared beam sensor. One infrared beam sensor is located at each boundary of the area which allows persons to enter or leave the area. For example, one infrared beam sensor is located at each door of the area. The infrared beam sensor uses infrared rays to detect people entering or leaving the area. A detection software determines the number of persons present in the area based on the data provided by the infrared beam sensor(s). When an infrared beam sensor reports one or more person entering the area, the detection software increases the number of persons present in the area accordingly. When an infrared beam sensor reports one or more person leaving the area, the detection software decreases the number of persons present in the area accordingly.

In a first implementation, the detection software is integrated to and executed by the infrared beam sensor; for instance when a single infrared beam sensor is used in the area. In this case, the determination at step 540 consists in receiving the number of persons present in the area from the infrared beam sensor. In another implementation, the detection software is executed by the processing unit 110 of the environment controller 100. In this case, the determination at step 540 consists in receiving the number of persons entering or leaving the area from the infrared beam sensor(s), and processing the number of persons entering or leaving the area with the detection software to determine the number of persons currently present in the area (based on a previously memorized number of persons present in the area). In still another implementation, the detection software is executed by another computing device (not represented in FIG. 1). The other computing device receives the number of persons entering or leaving the area from the infrared beam sensor(s), and processes the number of persons entering or leaving the area with the detection software to determine the number of persons currently present in the area (based on a previously memorized number of persons present in the area). In this case, the determination at step 540 consists in receiving the number of persons present in the area from the other computing device.

A person skilled in the art would readily understand that other types of occupancy sensors 230 may be used in the context of the present disclosure.

The order in which steps 525, 530, 535 and 540 are performed may vary. The order represented in FIG. 2A is for illustration purposes only.

The method 500 comprises the step 545 of executing the neural network inference engine 112 using the predictive model (stored at step 520) for generating outputs based on inputs. The execution of the neural network inference engine 112 is performed by the processing unit 110. The neural network inference engine 112 implements a neural network using the weights of the predictive model. This step will be further detailed later in the description.

The inputs comprise the temperature measurement in the area determined at step 525, the CO2 level measurement in the area determined at step 530, the humidity level measurement in the area determined at step 535, and the estimated number of persons present in the area determined at step 540.

The outputs comprise an inferred temperature, an inferred CO2 level, an inferred humidity level and an inferred number of persons.

The inputs used by the neural network inference engine 112 may include other parameter(s). For example, the inputs further include geometric characteristics of the area (e.g. a volume of the area, a surface of the area, a height of the area, a length of the area, a width of the area, a combination thereof, etc.). In another example, the inputs further include a human activity in the area (e.g. periods of time when the area is occupied by humans, a type of activity performed by humans occupying the area, etc.) For the two previously mentioned additional inputs, no corresponding additional output is used. However, an additional input (measured value of a new parameter) may be used, which also requires a corresponding additional output (inferred value of the new parameter) to be used. During the training phase, the predictive model generated by the neural network training engine 411 takes into account the additional input(s), and the corresponding additional output(s) if applicable.

The method 500 comprises the step 550 of applying a validation algorithm to the inputs and the outputs of the neural network inference engine 112, to determine if the estimated number of persons present in the area (determined at step 540) is accurate or not. Step 550 is performed by the control module 114 executed by the processing unit 110.

Different validation algorithms may be implemented at step 550. Following are examples of validation algorithms. However, a person skilled in the art would readily understand that other validation algorithms may be used in the context of the present disclosure. The result of the validation algorithm is referred to as the estimation, which is either accurate or inaccurate.

A first exemplary validation algorithm only performs a comparison of the estimated number of persons present in the area (determined at step 540) and the inferred number of persons (determined at step 545), to determine if the estimated number of persons present in the area is accurate or not.

In a first implementation, the estimation is accurate if the estimated number of persons present in the area is substantially equal to the inferred number of persons, and not accurate otherwise.

For example, if the estimated number of persons present in the area is 5 and the inferred number of persons is 5, then the estimation is accurate. But if the estimated number of persons present in the area is 5 and the inferred number of persons is 6, then the estimation is not accurate.

In a second implementation, the estimation is accurate if the difference between the estimated number of persons present in the area and the inferred number of persons is within a tolerance interval, and not accurate otherwise.

For example, the tolerance interval is defined by the range −0.3 to +0.3. If the estimated number of persons present in the area is 5 and the inferred number of persons is between 4.7 and 5.3, then the estimation is accurate. But if the estimated number of persons present in the area is 5 and the inferred number of persons is lower than 4.7 or greater than 5.3, then the estimation is not accurate.

A second exemplary validation algorithm takes into account all the inputs of step 545 (the temperature measurement in the area, the CO2 level measurement in the area, the humidity level measurement in the area and the estimated number of persons present in the area) and all the corresponding outputs of step 545 (the inferred temperature, the inferred CO2 level, the inferred humidity level and the inferred number of persons), to determine if the estimated number of persons present in the area is accurate or not.

In a first implementation, the estimation is accurate if: (the estimated number of persons present in the area is substantially equal to the inferred number of persons) AND (the temperature measurement in the area is substantially equal to the inferred temperature) AND (the CO2 level measurement in the area is substantially equal to the inferred CO2 level) AND (the humidity level measurement in the area is substantially equal to the inferred humidity level); and not accurate otherwise.

For example, (if the estimated number of persons present in the area is 5 and the inferred number of persons is 5) AND (the temperature measurement in the area is 27.5 degrees Celsius and the inferred temperature is 27.5 degrees Celsius) AND (the CO2 level measurement in the area is 800 parts-per-million (ppm) and the inferred CO2 level is 800 ppm) AND (the humidity level measurement in the area is 30% and the inferred humidity level is 30%), then the estimation is accurate.

But (if the estimated number of persons present in the area is 5 and the inferred number of persons is different from 5) OR (the temperature measurement in the area is 27.5 degrees Celsius and the inferred temperature is different from 27.5 degrees Celsius) OR (the CO2 level measurement in the area is 800 parts-per-million (ppm) and the inferred CO2 level is different from 800 ppm) OR (the humidity level measurement in the area is 30% and the inferred humidity level is different form 30%), then the estimation is not accurate.

In a second implementation, the estimation is accurate if: (the difference between the estimated number of persons present in the area and the inferred number of persons is within a first tolerance interval) AND (the difference between the temperature measurement in the area and the inferred temperature is within a second tolerance interval) AND (the difference between the CO2 level measurement in the area and the inferred CO2 level is within a third tolerance interval) AND (the difference between the humidity level measurement in the area and the inferred humidity level is within a fourth tolerance interval); and not accurate otherwise.

For example, the first tolerance interval is defined by the range −0.3 to +0.3, the second tolerance interval is defined by the range −0.4 to +0.4, the third tolerance interval is defined by the range −25 to +25, and the fourth tolerance interval is defined by the range −4 to +4.

If (the estimated number of persons present in the area is 5 and the inferred number of persons is between 4.7 and 5.3) AND (the temperature measurement in the area is 27.5 degrees Celsius and the inferred temperature is between 27.1 and 27.9 degrees Celsius) AND (the CO2 level measurement in the area is 800 parts-per-million (ppm) and the inferred CO2 level is between 775 and 825 ppm) AND (the humidity level measurement in the area is 30% and the inferred humidity level is between 26 and 34%), then the estimation is accurate.

But (if the estimated number of persons present in the area is 5 and the inferred number of persons is lower than 4.7 or greater than 5.3) OR (the temperature measurement in the area is 27.5 degrees Celsius and the inferred temperature is between lower than 27.1 or greater than 27.9 degrees Celsius) OR (the CO2 level measurement in the area is 800 parts-per-million (ppm) and the inferred CO2 level is lower than 775 or greater than 825 ppm) OR (the humidity level measurement in the area is 30% and the inferred humidity level is lower than 26 or greater than 34%), then the estimation is not accurate.

A person skilled in the art would readily understand that the validation algorithm may be implemented by other known algorithms allowing a characterization of a divergence between four target values and four corresponding calculated values.

If the validation algorithm determines that the estimated number of persons present in the area is accurate, then the estimated number of persons present in the area is used to generate command(s) to control the controlled appliance 300.

The method 500 comprises the step 555 of generating one or more command for controlling the controlled appliance 300, based on the estimated number of persons present in the area. Step 555 is performed by the control module 114 executed by the processing unit 110.

The generation of each command may use additional parameter(s), such as the temperature measurement determined at step 525, the CO2 level measurement determined at step 530, the humidity level measurement determined at step 535, other environmental data determined by the environment controller 100, set points (e.g. target temperature) received by the environment controller 100, etc.

As mentioned previously, an example of controlled appliance 300 is a VAV appliance. Examples of commands for controlling the VAV appliance 300 include commands directed to one of the following actuation modules of the VAV appliance 300: an actuation module controlling the speed of a fan, an actuation module controlling the pressure generated by a compressor, an actuation module controlling a valve defining the rate of an airflow, etc. For instance, the speed of the fan and the rate of the airflow increase when the number of persons present in the area increases. The algorithms for calculating the speed of the fan and the rate of the airflow, based on the number of persons present in the area and optionally other environmental characteristics, is out of the scope of the present disclosure. However, examples of such algorithms are well known in the art of environment control.

The method 500 comprises the step 560 of transmitting the command(s) (generated at step 555) to the controlled appliance 300 via the communication interface 130. Step 560 is performed by the control module 114 executed by the processing unit 110.

The method 500 comprises the step 565 of receiving the command(s) at the controlled appliance 300, via the communication interface of the controlled appliance 300. Step 565 is performed by the processing unit of the controlled appliance 300.

The method 500 comprises the step 570 of applying the command(s) at the controlled appliance 300. Step 570 is performed by the processing unit of the controlled appliance 300. Applying the command(s) consists in controlling one or more actuation module of the controlled appliance 300 based on the received command(s).

A single command or a plurality of commands is generated at step 555 and transmitted at step 560 to the same controlled appliance 300. Alternatively, the same command is generated at step 555 and transmitted at step 560 to a plurality of controlled appliances 300. In yet another alternative, a plurality of commands is generated at step 555 and transmitted at step 560 to a plurality of controlled appliances 300.

If the validation algorithm determines that the estimated number of persons present in the area is not accurate, then the environment controller 100 does not proceed with steps 555 and 560. The environment controller 100 may take various actions to handle the error in the determination of the estimated number of persons present in the area. Such actions are out of the scope of the present disclosure, which only focuses on the detection of the error, but does not address how to correct the error.

The method 500 comprises the step 575 of taking action(s) to handle the error in the determination of the estimated number of persons present in the area. Step 575 is performed by the processing unit of the controlled appliance 300. Examples of actions include sending an error message to a remote device via the communication interface 130, displaying an error message on the display 150, generating a sound corresponding to an error notification, resetting the algorithm used for determining the estimated number of persons present in the area at step 540, etc.

The steps of the method 500 involving the reception or the transmission of data by the environment controller 100 may use the same communication interface 130 or different communication interfaces 130. For example, step 515 uses a first communication interface 130 of the Ethernet type, while steps 525-540 and 560 use a second communication interface 130 of the Wi-Fi type. In another example, steps 515, 525-540 and 560 use the same communication interface 130 of the Wi-Fi type.

Simplified predictive models may be used by the neural network inference engine 112. The estimated number of persons present in the area is always included in the inputs of the neural network. Additionally, the inputs used at step 545 may only include the temperature measurement in the area and the CO2 level measurement in the area, and the outputs may only include the inferred temperature and the inferred CO2 level (step 535 is not needed). Alternatively, the inputs used at step 545 may only include the temperature measurement in the area and the humidity level measurement in the area, and the outputs may only include the inferred temperature and the inferred humidity level (step 530 is not needed). Alternatively, the inputs used at step 545 may only include the CO2 level measurement in the area and the humidity level measurement in the area, and the outputs may only include the inferred CO2 level and the inferred humidity level (step 525 is not needed). The validation algorithm used at step 550 also needs to be adapted if necessary. For example, if the input parameter and corresponding output parameter (temperature, CO2 level or humidity level) that is no longer used was taken into consideration by the validation algorithm, then the validation algorithm is adapted by no longer taking into consideration the input parameter and corresponding output parameter which is no longer used. The training phase is also adapted to generate the predictive model based on only two among the three parameters consisting of temperature, CO2 level or humidity level.

In an alternative implementation, instead of using a single measure of each parameter, a plurality of consecutive measures is used. The inputs used by the neural network inference engine 112 at step 545 include a plurality of consecutive temperature measurements, a plurality of consecutive CO2 level measurements, a plurality of consecutive humidity level measurements, and a plurality of consecutive estimated number of persons present in the area. The outputs generated by the neural network inference engine 112 include an inferred temperature, an inferred CO2 level, an inferred humidity level, and an inferred number of persons. The validation algorithm used at step 550 needs to be adapted accordingly, to take into account the usage of a plurality of values instead of a single value for each input parameter. The training phase also needs to be adapted, so that the neural network training engine 411 generates the predictive model based on a plurality of values instead of a single value for each input parameter. This alternative implementation will be detailed later in the description.

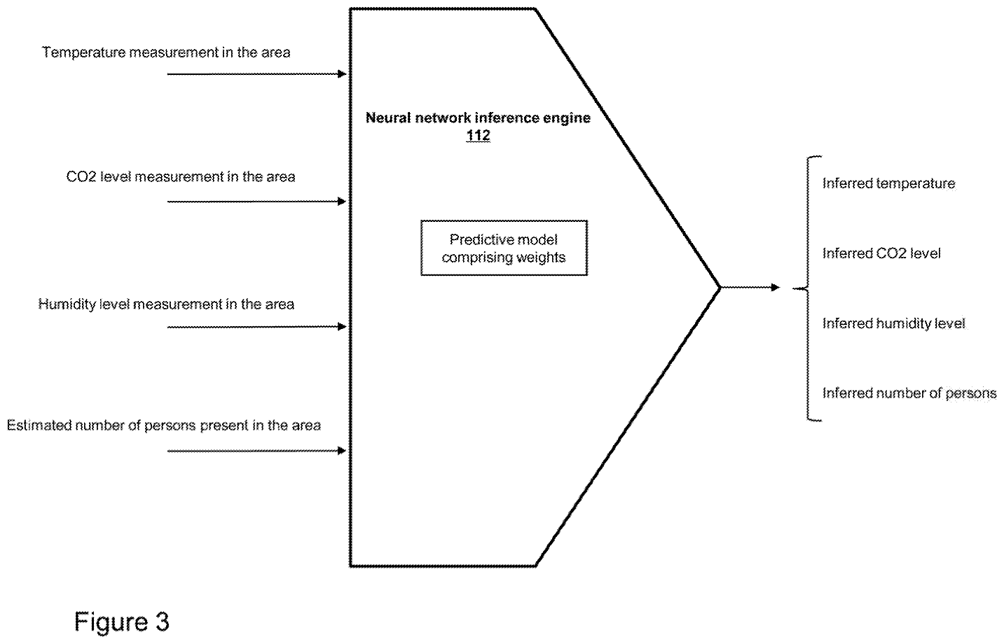

FIG. 3 is a schematic representation of the neural network inference engine 112 illustrating the inputs and the outputs used by the neural network inference engine 112 when performing step 545.

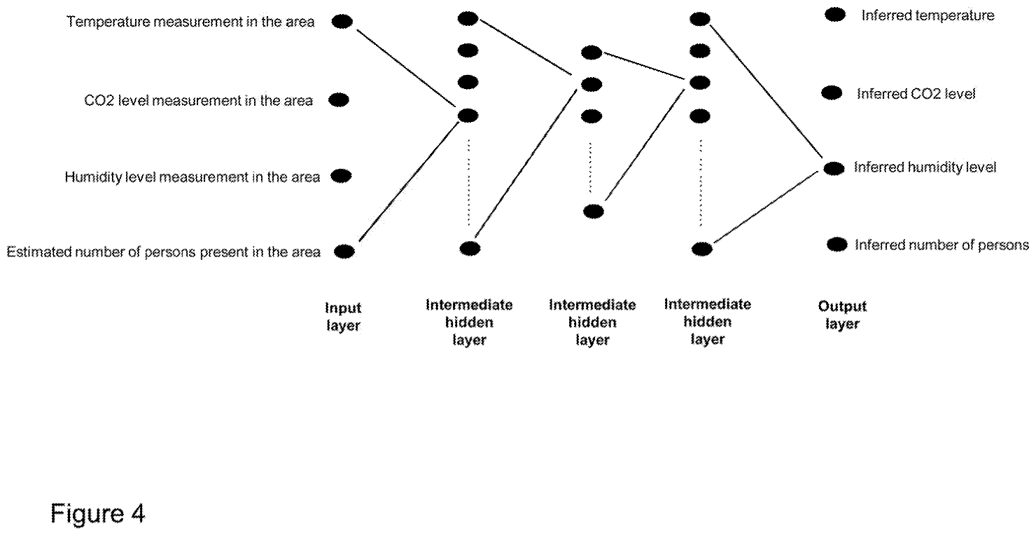

FIG. 4 is a detailed representation of the neural network implemented by the neural network inference engine 112.

The neural network includes an input layer with four neurons for receiving the four input values (the temperature measurement in the area, the CO2 level measurement in the area, the humidity level measurement in the area and the estimated number of persons present in the area). The neural network includes an output layer with four neurons for outputting the four output values (the inferred temperature, the inferred CO2 level, the inferred humidity level and the inferred number of persons). The neural network includes three intermediate hidden layers between the input layer and the output layer. All the layers are fully connected.

A layer L being fully connected means that each neuron of layer L receives inputs from every neurons of layer L−1, and applies respective weights to the received inputs. By default, the output layer is fully connected the last hidden layer.

The number of intermediate hidden layers is an integer greater or equal than 1 (FIG. 4 represents three intermediate hidden layers for illustration purposes only). The number of neurons in each intermediate hidden layer may vary. During the training phase of the neural network, the number of intermediate hidden layers and the number of neurons for each intermediate hidden layer are selected, and may be adapted experimentally.

The generation of the outputs based on the inputs using weights allocated to the neurons of the neural network is well known in the art. The architecture of the neural network, where each neuron of a layer (except for the first layer) is connected to all the neurons of the previous layer is also well known in the art.

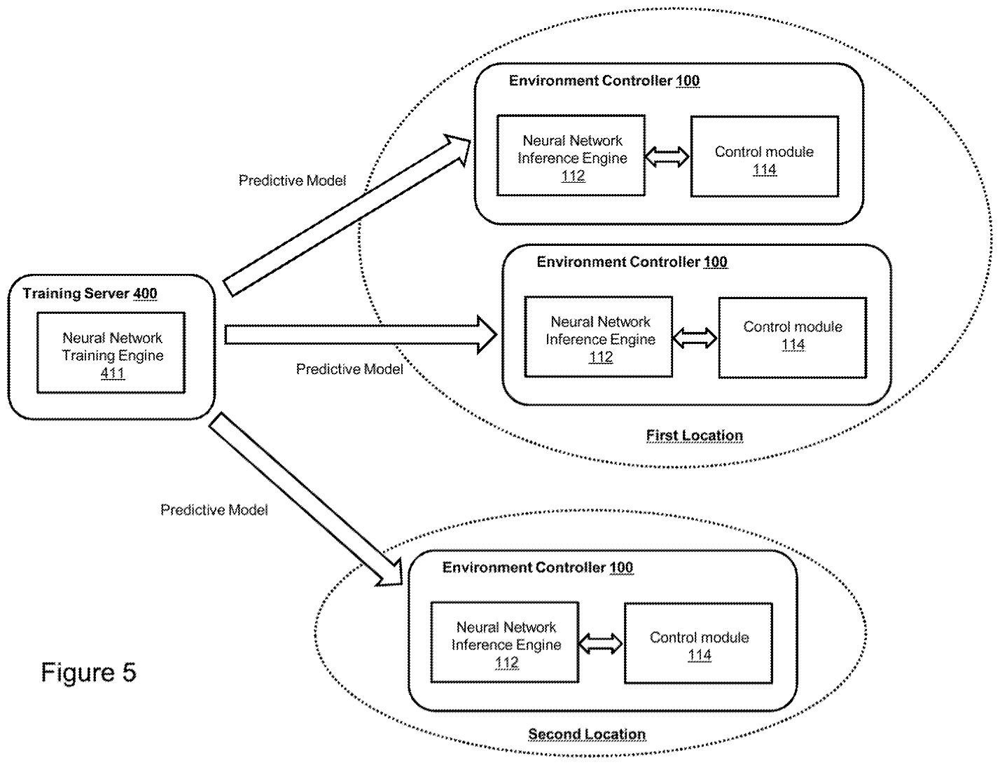

Reference is now made concurrently to FIGS. 1, 2A-B and 5, where FIG. 5 illustrates the usage of the method 500 in a large environment control system.

A first plurality of environment controllers 100 implementing the method 500 are deployed at a first location. Only two environment controllers 100 are represented for illustration purposes, but any number of environment controllers 100 may be deployed.

A second plurality of environment controllers 100 implementing the method 500 are deployed at a second location. Only one environment controller 100 is represented for illustration purposes, but any number of environment controllers 100 may be deployed.

The first and second locations may consist of different buildings, different floors of the same building, etc. Only two locations are represented for illustration purposes, but any number of locations may be considered.

Each environment controller 100 represented in FIG. 5 corresponds to the environment controller 100 represented in FIG. 1, and executes both the control module 114 and the neural network inference engine 112. Each environment controller 100 receives a predictive model from the centralized training server 400 (e.g. a cloud based training server 400 in communication with the environment controllers 100 via a networking infrastructure, as is well known in the art). The same predictive model is used for all the environment controllers 100. Alternatively, a plurality of predictive models is generated, and takes into account specific operating conditions of the environment controllers 100. For example, a first predictive model is generated for the environment controllers 100 controlling a first area having a first set of geometric properties, and a second predictive model is generated for the environment controllers 100 controlling a second area having a second set of geometric properties. Examples of geometric properties include a volume of the area, a surface of the area, a shape of the area, a height of the area, etc.

FIG. 5 illustrates a decentralized architecture, where the environment controllers 100 take autonomous decisions for controlling the controlled appliances 300, using the predictive model as illustrated in the method 500.

In an alternative configuration, at least some of the environment controllers 100 also execute the neural network training engine 411. In this case, the training phase (performed by the neural network training engine 411 for generating the predictive model) and the operational phase (performed by the neural network inference engine 112) are both executed by the environment controller 100.

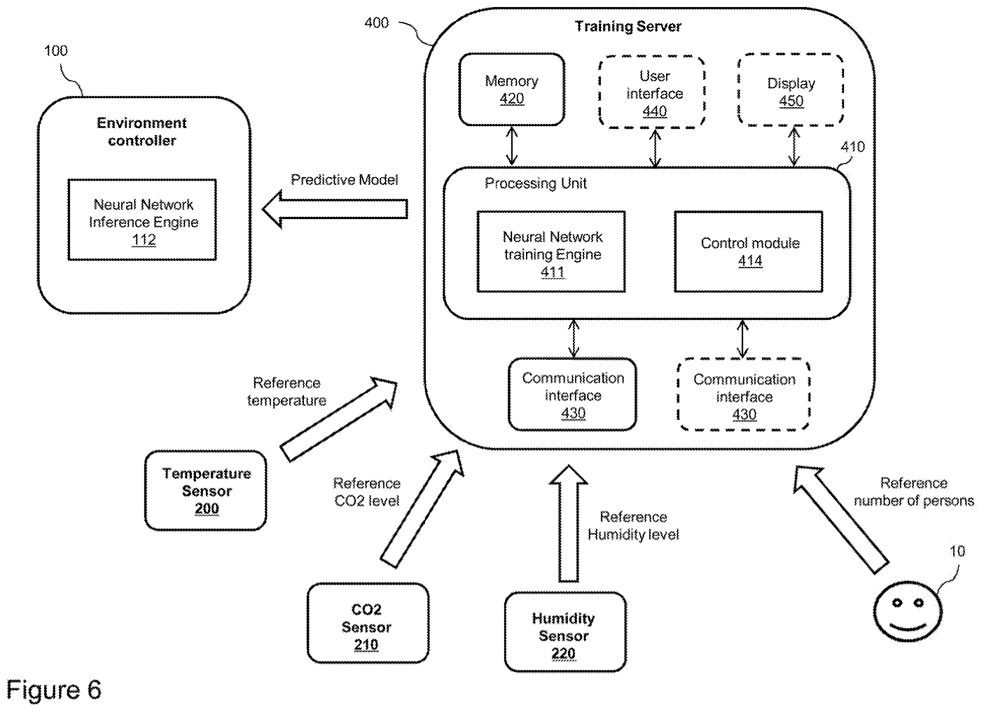

Referring now to FIGS. 1 and 6, details of the components of the training server 400 represented in FIG. 1 are provided in FIG. 6.

The training server 400 comprises a processing unit 410, memory 420, and a communication interface 430. The training server 400 may comprise additional components, such as another communication interface 430, a user interface 440, a display 450, etc.

The characteristics of the processing unit 410 of the training server 400 are similar to the previously described characteristics of the processing unit 110 of the environment controller 100. The processing unit 410 executes the neural network training engine 411 and a control module 414.

The characteristics of the memory 420 of the training server 400 are similar to the previously described characteristics of the memory 120 of the environment controller 100.

The characteristics of the communication interface 430 of the training server 400 are similar to the previously described characteristics of the communication interface 130 of the environment controller 100.

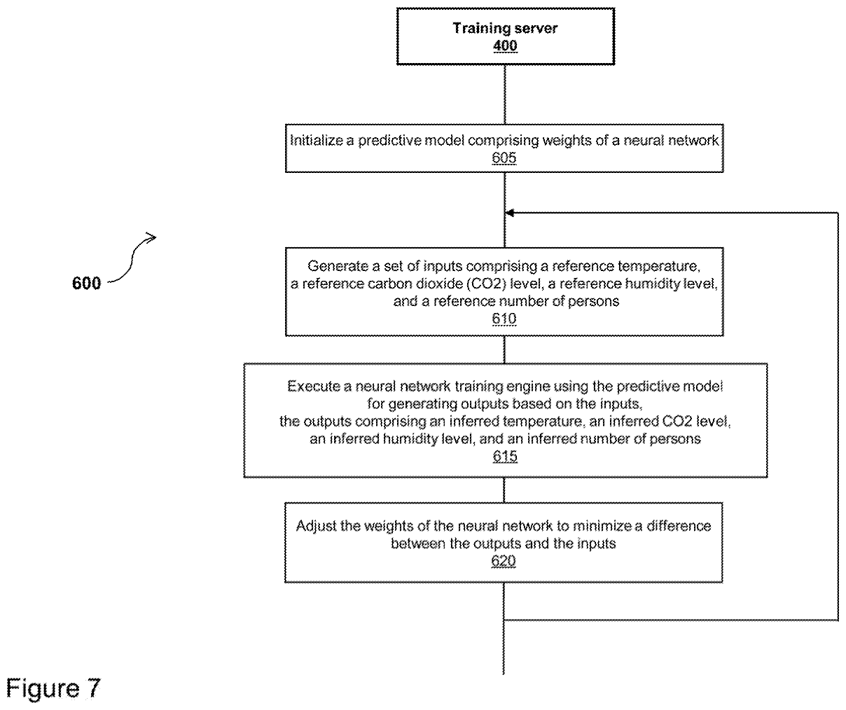

Reference is now made concurrently to FIGS. 1, 6 and 7. FIG. 7 represents a method 600 for training a neural network to validate an estimation of a number of persons present in an area. At least some of the steps of the method 600 represented in FIG. 7 are implemented by the training server 400. The present disclosure is not limited to the method 600 being implemented by the training server 400, but is applicable to any type of computing device capable of implementing the steps of the method 600.

A dedicated computer program has instructions for implementing at least some of the steps of the method 600. The instructions are comprised in a non-transitory computer program product (e.g. the memory 420) of the training server 400. The instructions provide for training a neural network to validate an estimation of a number of persons present in an area, when executed by the processing unit 410 of the training server 400. The instructions are deliverable to the training server 400 via an electronically-readable media such as a storage media (e.g. CD-ROM, USB key, etc.), or via communication links (e.g. via a communication network through the communication interface 430).

The instructions of the dedicated computer program executed by the processing unit 410 implement the neural network training engine 411 and the control module 414. The neural network training engine 411 provides functionalities of a neural network, allowing to generate a predictive model ready to be used by the neural network inference engine 112 at the end of the training, as is well known in the art. The control module 414 provides functionalities allowing the training server 400 to gather data used for the training of the neural network.

The method 600 comprises the step 605 of initializing a predictive model used by the neural network implemented by the neural network training engine 411. Step 605 is performed by the control module 414 executed by the processing unit 410 of the training server 400. The predictive model comprises the weights of the neural network implemented by the neural network training engine 411.

The initialization of the predictive model comprises defining a number of layers of the neural network, a number of neurons per layer, an initial value for the weights of the neural network, etc.

The definition of the number of layers and the number of neurons per layer is performed by a person highly skilled in the art of neural networks.

Different algorithms (well documented in the art) can be used for allocating an initial value to the weights of the neural network. For example, each weight is allocated a random value within a given interval (e.g. a real number between −0.5 and +0.5), which can be adjusted if the random value is too close to a minimum value (e.g. −0.5) or too close to a maximum value (e.g. +0.5).

The data used for the initialization of the predictive model are received from a person via the user interface 440, and/or received from a remote computing device (not represented in FIG. 6) via the communication interface 430, and/or generated by a software program executed by the processing unit 410 (e.g. random generation of the initial value of the weights).

Although not represented in FIG. 7 for simplification purposes, the predictive model initialized at step 605 is stored in the memory 420 of the training server 400.

The method 600 comprises the step 610 of generating a set of inputs comprising a reference temperature, a reference carbon dioxide (CO2) level, a reference humidity level and a reference number of persons. Step 610 is performed by the control module 414 executed by the processing unit 410 of the training server 400.

The method 600 comprises the step 615 of executing the neural network training engine 411, using the predictive model for generating outputs based on the inputs (generated at step 610). The execution of the neural network training engine 411 is performed by the processing unit 410 of the training server 400. The neural network training engine 411 implements a neural network using the weights of the predictive model.

The inputs have been defined at step 610. The outputs comprise an inferred temperature, an inferred CO2 level, an inferred humidity level and an inferred number of persons.

The neural network implemented by the neural network training engine 411 corresponds to the neural network implemented by the neural network inference engine 112 (same number of layers, same number of neurons per layer). As mentioned previously, FIG. 4 is a detailed representation of such a neural network.

The method 600 comprises the step 620 of adjusting the weights of the neural network to minimize a difference between the outputs (generated at step 615) and the inputs (generated at step 610). Step 620 is performed by the neural network training engine 411 executed by the processing unit 410 of the training server 400.

Although not represented in FIG. 7 for simplification purposes, the modifications to the weights of the neural network performed at step 620 are stored in the memory 420 of the training server 400.

Steps 605, 610, 615 and 620 of the method 600 correspond to step 505 of the method 500 represented in FIG. 2A.

As is well known in the art, steps 610-615-620 are repeated for a plurality of different sets of inputs generated at step 610. The plurality of sets of inputs need to be large enough to properly train the neural network.

At the end of the training phase, the neural network is considered to be properly trained, and the predictive model comprising the final version of the weights is transmitted to the environment controller 100, as illustrated by step 510 of the method 500 represented in FIG. 2A.

A plurality of sets of test inputs is optionally used to validate the accuracy of the predictive model. The sets of test inputs are different from the sets of training inputs used at steps 610-615-620. This procedure well known in the art of neural networks is not represented in FIG. 7 for simplification purposes.

Various techniques well known in the art of neural networks can be used for performing step 620. For example, the adjustment of the weights of the neural network at step 620 uses back propagation. Other techniques, such as the usage of bias in addition to the weights (bias and weights are generally collectively referred to as weights in the neural network terminology), reinforcement training, etc., may also be used.

Furthermore, the evaluation of the difference between the inputs and the outputs of the neural network at step 620 may be implemented in different ways. In a first exemplary implementation, adjusting the weights of the neural network to minimize a difference between the outputs and the inputs comprises adjusting the weights so that the inferred temperature is substantially equal to the reference temperature, the inferred CO2 level is substantially equal to the reference CO2 level, the inferred humidity level is substantially equal to the reference humidity level, and the inferred number of persons is substantially equal to the reference number of persons.

In a second exemplary implementation, adjusting the weights of the neural network to minimize a difference between the outputs and the inputs comprises adjusting the weights so that a difference between the inferred temperature and the reference temperature is within a first tolerance interval, a difference between the inferred CO2 level and the reference CO2 level is within a second tolerance interval, a difference between the inferred humidity level and the reference humidity level is within a third tolerance interval, and a difference between the inferred number of persons and the reference number of persons is within a fourth tolerance interval.

The collection of the data used for generating the sets of inputs at step 610 may be implemented in different manners. In a first exemplary implementation, the refence temperature, the reference CO2 level and the reference humidity level are respectively collected from temperature, CO2 and humidity sensors, as per steps 525, 530 and 535 of the method 500 illustrated in FIG. 2A. For instance, the reference temperature, the reference CO2 level and the reference humidity level are respectively received via the communication interface 430 from the temperature sensor 200, the CO2 sensor 210 and the humidity sensors 220 (deployed in the area under consideration). For a given set of refence temperature, reference CO2 level and reference humidity level, a human being 10 counts the number of persons present in the area and transmits this number of persons present in the area to the training server 400 (e.g. via the user interface 440 or the communication interface 430). The number of persons present in the area determined by the human being 10 is used as the reference number of persons at step 610. This first exemplary implementation is illustrated in FIG. 6. In a second exemplary implementation, multiples sets of inputs are collected independently of the training server 400, through an experimental process which is out of the scope of the present disclosure. When a sufficient number of sets of inputs has been collected, the sets of inputs are transmitted to the training server 400. The sets of inputs are received via the communication interface 430 in the form of a file containing the sets of inputs used at step 610.

As mentioned previously, the neural network training engine 411 and the neural network inference engine 112 may be implemented by the same computing device (e.g. the environment controller 100). In this case, the steps of the method 600 and steps 515-560 and 575 of the method 500 (represented in FIGS. 2A and 2B) are performed by the same computing device.

### Neural Network Using a Plurality of Consecutive Values for Each Input Parameter

Following is a detailed description of the aforementioned alternative implementation, where instead of using a single measure of each parameter as inputs of the neural network, a plurality of consecutive measures is used for each parameter.

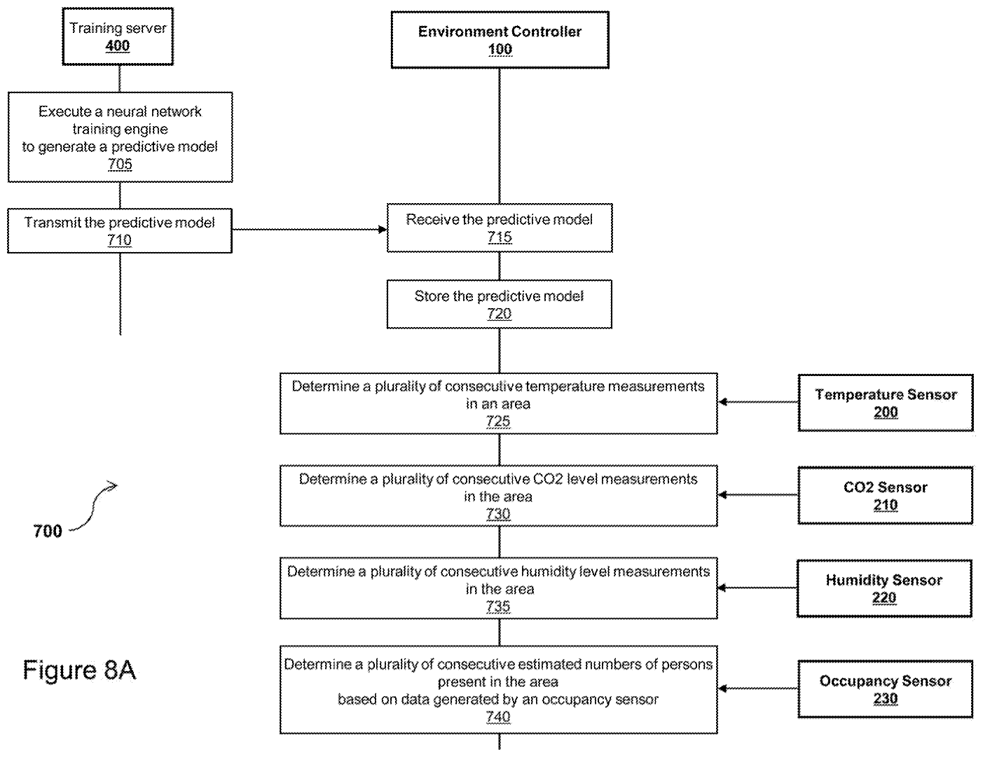

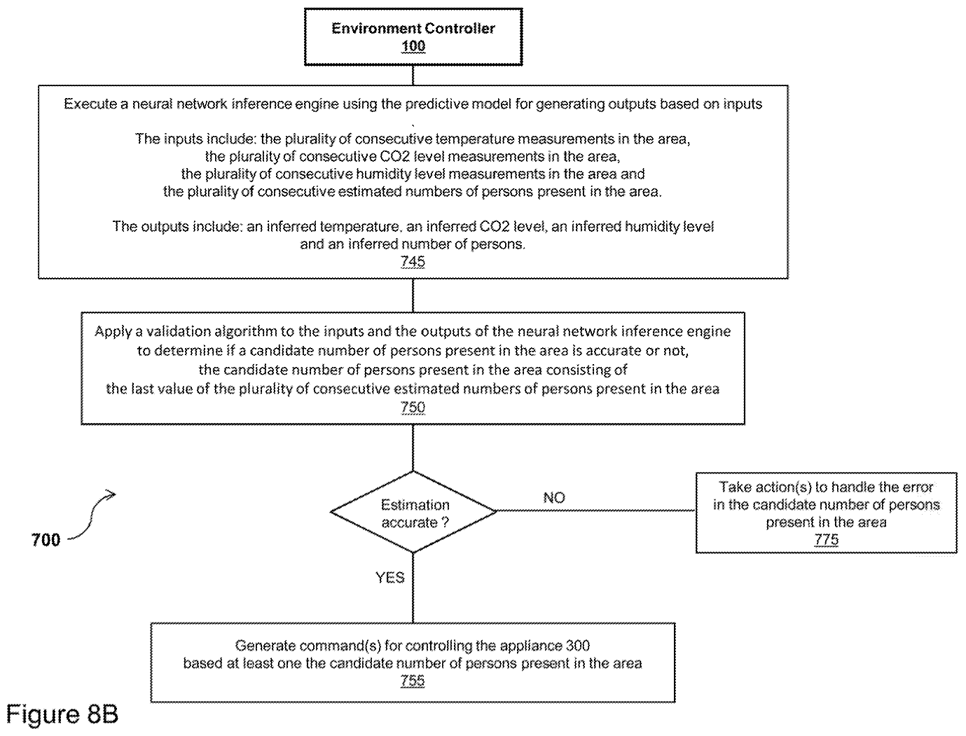

Reference is now made concurrently to FIGS. 1, 2A, 2B, 8A and 8B; where FIGS. 8A and 8B represent a method 700. At least some of the steps of the method 700 are implemented by the environment controller 100. The method 700 aims at validating an estimated number of persons present in an area, the estimated number being determined through an occupancy sensor. The present disclosure is not limited to the method 700 being implemented by the environment controller 100, but is applicable to any type of computing device capable of implementing the steps of the method 700.

A dedicated computer program has instructions for implementing at least some of the steps of the method 700. The instructions are comprised in a non-transitory computer program product (e.g. the memory 120) of the environment controller 100. The instructions provide for validating an estimated number of persons present in an area determined through an occupancy sensor, when executed by the processing unit 110 of the environment controller 100. The instructions are deliverable to the environment controller 100 via an electronically-readable media such as a storage media (e.g. CD-ROM, USB key, etc.), or via communication links (e.g. via a communication network through the communication interface 130). As mentioned previously, the instructions of the dedicated computer program executed by the processing unit 110 implement the neural network inference engine 112 and the control module 114.

The method 700 comprises the step 705 of executing the neural network training engine 411 to generate the predictive model. Step 705 is performed by the processing unit of the training server 400. The predictive model comprises weights of a neural network implemented by the neural network training engine 411. This step is similar to step 505 of the method 500.

The method 700 comprises the step 710 of transmitting the predictive model generated at step 705 to the environment controller 100, via the communication interface of the training server 400. Step 710 is performed by the processing unit of the training server 400. This step is similar to step 510 of the method 500.

The method 700 comprises the step 715 of receiving the predictive model from the training server 400, via the communication interface 130 of the environment controller 100. Step 715 is performed by the processing unit 110 of the environment controller 100. This step is similar to step 515 of the method 500.

The method 700 comprises the step 720 of storing the predictive model in the memory 120 of the environment controller 100. Step 720 is performed by the processing unit 110 of the environment controller 100. This step is similar to step 520 of the method 500.

The method 700 comprises the step 725 of determining a plurality of consecutive temperature measurements in the area. Step 725 is performed by the control module 114 executed by the processing unit 110. This step is similar to step 525 of the method 500 with the following difference. In step 525, a single temperature measurement is determined and used as input of the neural network at step 545. In step 725, a plurality of consecutive temperature measurements is determined and used as inputs of the neural network at step 745. However, the determination of each one among the plurality of consecutive temperature measurements at step 725 is similar to the determination of the single temperature measurement at step 525.

The method 700 comprises the step 730 of determining a plurality of consecutive CO2 level measurements in the area. Step 730 is performed by the control module 114 executed by the processing unit 110. This step is similar to step 530 of the method 500 with the following difference. In step 530, a single CO2 level measurement is determined and used as input of the neural network at step 545. In step 730, a plurality of consecutive CO2 level measurements is determined and used as inputs of the neural network at step 745. However, the determination of each one among the plurality of consecutive CO2 level measurements at step 730 is similar to the determination of the single CO2 level measurement at step 530.

The method 700 comprises the step 735 of determining a plurality of consecutive humidity level measurements in the area. Step 735 is performed by the control module 114 executed by the processing unit 110. This step is similar to step 535 of the method 500 with the following difference. In step 535, a single humidity level measurement is determined and used as input of the neural network at step 545. In step 735, a plurality of consecutive humidity level measurements is determined and used as inputs of the neural network at step 745. However, the determination of each one among the plurality of consecutive humidity level measurements at step 735 is similar to the determination of the single humidity level measurement at step 535.

The method 700 comprises the step 740 of determining a plurality of consecutive estimated numbers of persons present in the area based on data generated by the occupancy sensor 230. Step 740 is performed by the control module 114 executed by the processing unit 110 This step is similar to step 540 of the method 500 with the following difference. In step 540, a single estimated number of persons present in the area is determined and used as input of the neural network at step 545. In step 740, a plurality of consecutive estimated numbers of persons present in the area is determined and used as inputs of the neural network at step 745. However, the determination of each one among the plurality of consecutive estimated numbers of persons present in the area at step 740 is similar to the determination of the single estimated number of persons present in the area at step 540.

The implementation of steps 725, 730, 735 and 740 may vary. For example, the environment controller 100 receives a constant flow of data from the temperature sensor 200, from the CO2 sensor 210, from the humidity sensor 200, and from the occupancy sensor 230. These data are processed (if needed) to generate the consecutive temperature measurements, the consecutive CO2 level measurements, the consecutive humidity level measurements, and the consecutive estimated numbers of persons; which are all stored in the memory 120. The last m determined temperature measurements, the last n determined CO2 level measurements, the last o determined humidity level measurements and the last p estimated numbers of persons (stored in the memory) are used when performing step 745; where m, n, o and p are integers having the same or different values (as will be illustrated later in the description).

The method 700 comprises the step 745 of executing the neural network inference engine 112 using the predictive model (stored at step 720) for generating outputs based on inputs. The execution of the neural network inference engine 112 is performed by the processing unit 110. The neural network inference engine 112 implements a neural network using the weights of the predictive model. This step is similar to step 545 of the method 500, but the inputs of the neural network are different in steps 745 and 545. This step will be further detailed later in the description.

The inputs comprise the plurality of consecutive temperature measurements in the area determined at step 725, the plurality of consecutive CO2 level measurements in the area determined at step 730, the plurality of consecutive humidity level measurements in the area determined at step 735, and the plurality of consecutive estimated numbers of persons present in the area determined at step 740.

The outputs comprise an inferred temperature, an inferred CO2 level, an inferred humidity level and an inferred number of persons (the outputs of the neural network are the same in steps 745 and 545).

As mentioned for step 545, the inputs used by the neural network inference engine 112 at step 745 may include other parameter(s). For example, the inputs further include geometric characteristics of the area (e.g. a volume of the area, a surface of the area, a height of the area, a length of the area, a width of the area, a combination thereof, etc.). In another example, the inputs further include a human activity in the area (e.g. periods of time when the area is occupied by humans, a type of activity performed by humans occupying the area, etc.) For the two previously mentioned additional inputs, no corresponding additional output is used. However, an additional input (measured value of a new parameter) may be used, which also requires a corresponding additional output (inferred value of the new parameter) to be used. During the training phase, the predictive model generated by the neural network training engine 411 takes into account the additional input(s), and the corresponding additional output(s) if applicable.

The method 700 comprises the step 750 of applying a validation algorithm to the inputs and the outputs of the neural network inference engine 112, to determine if a candidate number of persons present in the area is accurate or not. Step 750 is performed by the control module 114 executed by the processing unit 110. This step is similar to step 550 of the method 500, but the validation algorithm needs to be adapted to the inputs of the neural network used at step 745, which are different from the inputs of the neural network used at step 545. In particular, the candidate number of persons present in the area consists of the last value of the plurality of consecutive estimated numbers of persons present in the area (determined at step 740).

For example, an estimated number of persons present in the area is received every minute from the occupancy sensor 230. The last 5 received estimated numbers of persons are memorized and used as inputs of the neural network at step 745. At instant t, the estimated number Nₜ is received, and the estimated numbers Nₜ₋₁ (received at t minus one minute), Nₜ₋₂ (received at t minus two minutes), Nₜ₋₃ (received at t minus three minutes) and Nₜ₋₄ (received at t minus four minutes) were previously memorized. The plurality of consecutive estimated number of persons used at step 745 is [Nₜ₋₄, Nₜ₋₃, Nₜ₋₂, Nₜ₋₁, Nₜ], and the candidate number of persons present in the area is Nₜ.

Following are adaptations of the validation algorithms previously described in relation to step 550. The result of the validation algorithm is referred to as the estimation, which is either accurate or inaccurate. As mentioned previously, the candidate number of persons present in the area is equal to the last value of the plurality of consecutive estimated numbers of persons present in the area (determined at step 740),

A first exemplary validation algorithm only performs a comparison of the candidate number of persons present in the area and the inferred number of persons (determined at step 745), to determine if the estimated number of persons present in the area is accurate or not.

In a first implementation, the estimation is accurate if the candidate number of persons present in the area is substantially equal to the inferred number of persons, and not accurate otherwise.

In a second implementation, the estimation is accurate if the difference between the candidate number of persons present in the area and the inferred number of persons is within a tolerance interval, and not accurate otherwise.

A second exemplary validation algorithm takes into account all types of inputs of step 745 (the temperature measurement in the area, the CO2 level measurement in the area, the humidity level measurement in the area and the estimated number of persons present in the area) and all the corresponding outputs of step 545 (the inferred temperature, the inferred CO2 level, the inferred humidity level and the inferred number of persons), to determine if the candidate number of persons present in the area is accurate or not.

In a first implementation, the estimation is accurate if: (the candidate number of persons present in the area is substantially equal to the inferred number of persons) AND (the last value of the plurality of consecutive temperature measurements in the area is substantially equal to the inferred temperature) AND (the last value of the plurality of consecutive CO2 level measurements in the area is substantially equal to the inferred CO2 level) AND (the last value of the plurality of consecutive humidity level measurements in the area is substantially equal to the inferred humidity level); and not accurate otherwise.

In a second implementation, the estimation is accurate if: (the difference between the candidate number of persons present in the area and the inferred number of persons is within a first tolerance interval) AND (the difference between the last value of the plurality of consecutive temperature measurements in the area and the inferred temperature is within a second tolerance interval) AND (the difference between the last value of the plurality of consecutive CO2 level measurements in the area and the inferred CO2 level is within a third tolerance interval) AND (the difference between the last value of the plurality of consecutive humidity level measurements in the area and the inferred humidity level is within a fourth tolerance interval); and not accurate otherwise.

A person skilled in the art would readily understand that the validation algorithm may be implemented by other known algorithms allowing a characterization of a divergence between four target values and four corresponding calculated values.

If the validation algorithm determines that the candidate number of persons present in the area is accurate, then the candidate number of persons present in the area is used to generate command(s) to control the controlled appliance 300.

The method 700 comprises the step 755 of generating one or more command for controlling the controlled appliance 300, based on the candidate number of persons present in the area. Step 755 is performed by the control module 114 executed by the processing unit 110. This step is similar to step 555 of the method 500.

The steps of transmitting the command(s) to the controlled appliance 300, receiving the command(s) at the controlled appliance 300 and applying the command(s) by the controlled appliance 300 are not represented in FIG. 8B for simplification purposes. These steps are similar to step 560, 565 and 570 of the method 500.

If the validation algorithm determines that the candidate number of persons present in the area is not accurate, then the environment controller 100 does not proceed with steps 755. The environment controller 100 may take various actions to handle the error in the determination of the candidate number of persons present in the area. Such actions are out of the scope of the present disclosure, which only focuses on the detection of the error, but does not address how to correct the error.

The method 700 comprises the step 775 of taking action(s) to handle the error in the determination of the candidate number of persons present in the area. Step 775 is performed by the processing unit of the controlled appliance 300. This step is similar to step 575 of the method 500.

Simplified predictive models may be used by the neural network inference engine 112. The plurality of consecutive estimated numbers of persons present in the area is always included in the inputs of the neural network. Additionally, the inputs used at step 745 may only include the plurality of consecutive temperature measurements in the area and the plurality of consecutive CO2 level measurements in the area, and the outputs may only include the inferred temperature and the inferred CO2 level (step 735 is not needed). Alternatively, the inputs used at step 745 may only include the plurality of consecutive temperature measurements in the area and the plurality of consecutive humidity level measurements in the area, and the outputs may only include the inferred temperature and the inferred humidity level (step 730 is not needed). Alternatively, the inputs used at step 545 may only include the plurality of consecutive CO2 level measurements in the area and the plurality of consecutive humidity level measurements in the area, and the outputs may only include the inferred CO2 level and the inferred humidity level (step 725 is not needed). The validation algorithm used at step 750 also needs to be adapted if necessary. For example, if the type of input parameter and corresponding output parameter (temperature, CO2 level or humidity level) that is no longer used was taken into consideration by the validation algorithm, then the validation algorithm is adapted by no longer taking into consideration the type of input parameter and corresponding output parameter which is no longer used. The training phase is also adapted to generate the predictive model based on only two among the three types of parameters consisting of temperature, CO2 level or humidity level.

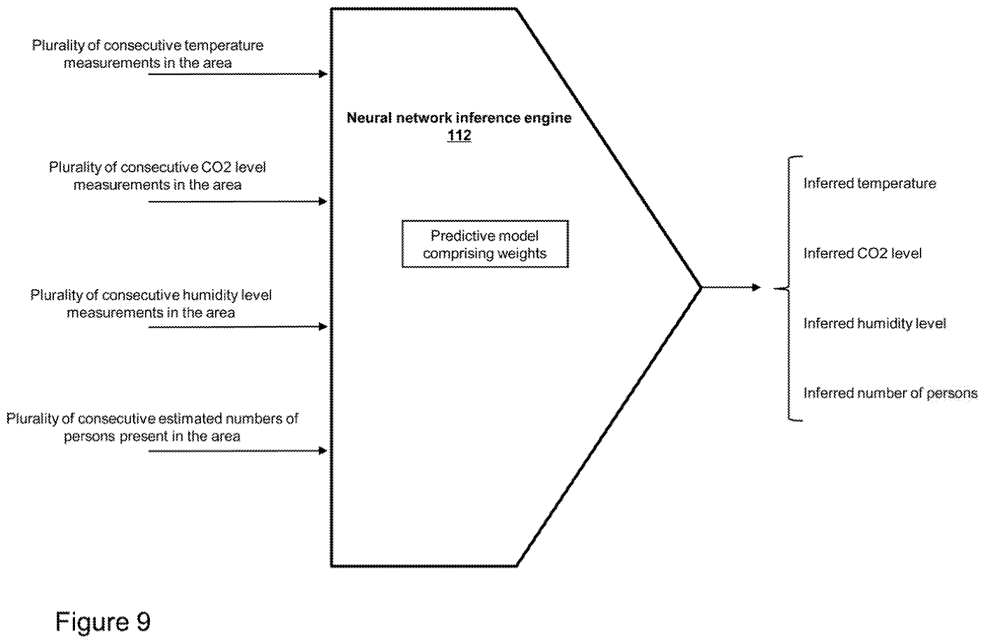

FIG. 9 is a schematic representation of the neural network inference engine 112 illustrating the inputs and the outputs used by the neural network inference engine 112 when performing step 745.

The inputs include m consecutive temperature measurements, n consecutive CO2 level measurements, o consecutive humidity level measurements, and p consecutive estimated numbers of persons present in the area. m, n, o and p are integers having the same value (e.g. 10) or different values (e.g. respectively 10, 5, 10 and 5).

For illustration purposes, we consider a set of m consecutive temperature measurements T₁, T₂ . . . Tₘ. We consider a set of n consecutive CO2 level measurements C₁, C₂ . . . Cₙ. We consider a set of o consecutive humidity level measurements H₁, H₂ . . . Hₒ. We consider a set of p consecutive estimated numbers of persons present in the area E₁, E₂ . . . Eₚ.

In a first implementation, the neural network inference engine 112 implements a neural network comprising an input layer, followed by one or more intermediate hidden layer, followed by an output layer; where the hidden layers are fully connected.

The input layer comprises at least m+n+o+p neurons. The first m input neurons receive them consecutive temperature measurements T₁, T₂ . . . Tₘ. The next n input neurons receive the n consecutive CO2 level measurements C₁, C₂ . . . Cₙ. The next o input neurons receive the o consecutive humidity level measurements H₁, H₂ . . . Hₒ. The next p input neurons receive the p consecutive estimated numbers of persons present in the area E₁, E₂ . . . Eₚ. The output layer comprises four neurons outputting the inferred temperature, the inferred CO2 level, the inferred humidity level and the inferred number of persons. The integers m, n, o and p may have the same or different values.

The architecture of the neural network is similar to the one represented in FIG. 4, with three intermediate hidden layers between the input layer and the output layer. All the layers are fully connected. As mentioned previously, the generation of the outputs based on the inputs using weights allocated to the neurons of the neural network is well known in the art for a neural network using only fully connected hidden layers. The architecture of the neural network, where each neuron of a layer (except for the first layer) is connected to all the neurons of the previous layer is also well known in the art.

The number of intermediate hidden layers is an integer greater or equal than 1 (FIG. 4 represents three intermediate hidden layers for illustration purposes only). The number of neurons in each intermediate hidden layer may vary. During the training phase of the neural network, the number of intermediate hidden layers and the number of neurons for each intermediate hidden layer are selected, and may be adapted experimentally.

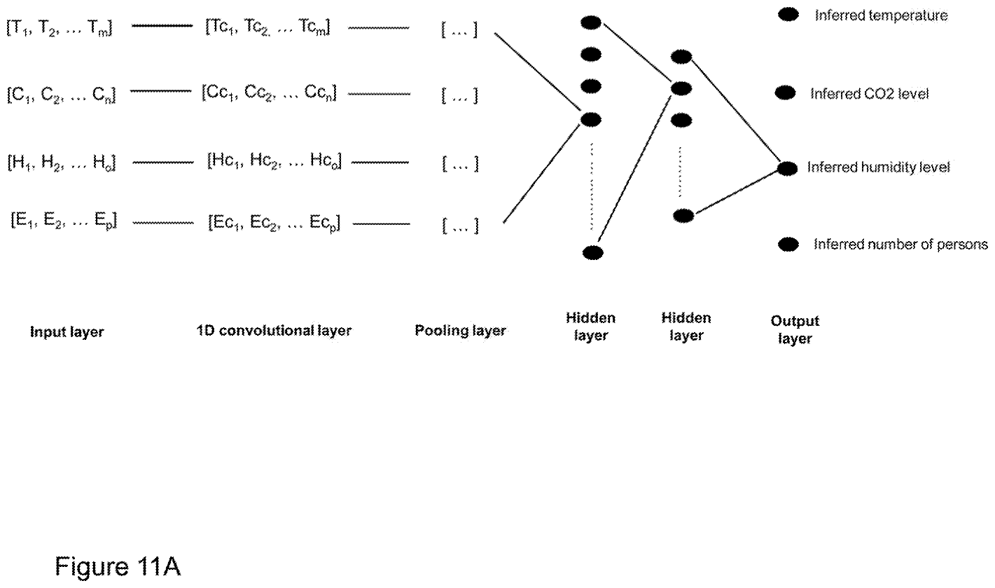

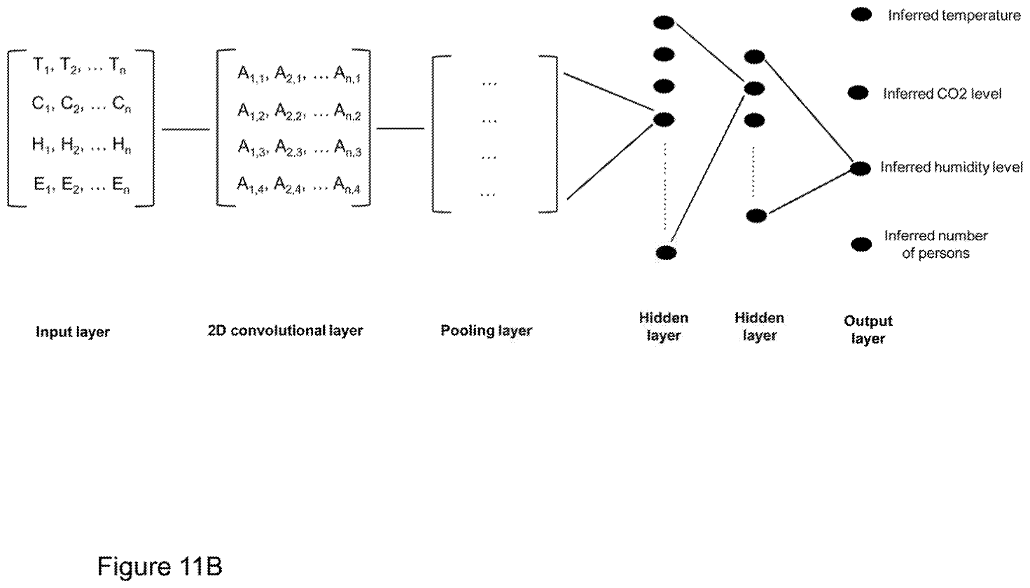

In a second implementation represented in FIG. 11A, the neural network inference engine 112 implements a one dimensional (1D) convolutional neural network comprising an input layer, followed by one or more 1D convolutional layer, followed by one or more intermediate hidden layer, followed by an output layer. Optionally, each 1D convolutional layer is followed by a pooling layer.

The input layer comprises 4 neurons. The first neuron of the input layer receives a first one-dimension matrix consisting of the m consecutive temperature measurements Tᵢ, with i varying from 1 to m. The second neuron of the input layer receives a second one-dimension matrix consisting of the n consecutive humidity level measurements Hⱼ, with j varying from 1 to n. The third neuron of the input layer receives a third one-dimension matrix consisting of the o consecutive humidity level measurements Hₖ, with k varying from 1 to o. The fourth neuron of the input layer receives a fourth one-dimension matrix consisting of the p consecutive estimated numbers of persons present in the area Eₗ, with l varying from 1 to p. The integers m, n, o and p may have the same or different values.

The first layer following the input layer is the 1D convolutional layer applying four respective 1D convolutions to the four matrices. The first 1D convolution uses a one dimension filter of size lower than m. The second 1D convolution uses a one dimension filter of size lower than n. The third 1D convolution uses a one dimension filter of size lower than o. The fourth 1D convolution uses a one dimension filter of size lower than p.

The output of the 1D convolutional layer consists in four respective resulting matrixes [T_{C1}, T_{C2}, . . . T_{Cm}], [C_{C1}, C_{C2}, . . . C_{Cn}], [H_{C1}, H_{C2}, . . . H_{Co}] and [E_{C1}, E_{C2}, . . . E_{Cp}]. As mentioned previously, the 1D convolutional layer may be followed by a pooling layer for reducing the size of the four resulting matrixes into four respective reduced matrixes (of size respectively lower than m, n, o and p). Details of the pooling layer are not represented in FIG. 11A for simplification purposes. Various algorithms (e.g. maximum value, minimum value, average value, etc.) can be used for implementing the pooling layer, as is well known in the art (a one dimension filter of given size is also used by the pooling layer).

The neural network may include several consecutive 1D convolutional layers, optionally respectively followed by pooling layers. The four input matrixes [T₁, T₂, . . . Tₘ], [C₁, C₂, . . . Cₙ], [H₁, H₂, . . . Cₒ], and [E₁, E₂, . . . Eₚ] are processed independently from one another along the chain of 1D convolutional layer(s) and optional pooling layer(s).

The chain of 1D convolutional layer(s) and optional pooling layer(s) is followed by the one or more fully connected hidden layer, which operates with weights associated to neurons, as is well known in the art.

In a third implementation represented in FIG. 11B, the neural network inference engine 112 implements a two dimensional (2D) convolutional neural network comprising an input layer, followed by one or more 2D convolutional layer, followed by one or more intermediate hidden layer, followed by an output layer. Optionally, each 2D convolutional layer is followed by a pooling layer. The integers m, n, o and p have the same value (referred as n in the following) to perform the 2D convolution(s).

The input layer comprises at least one neuron receiving a two-dimensions (n×4) matrix with the n consecutive temperature measurements on the first line, the n consecutive humidity level measurements on the second line, the n consecutive humidity level measurements on the third line, and the n consecutive estimated numbers of persons present in the area on the fourth line. Following is a representation of the input matrix:

[T₁, T₂, . . . Tₙ,
C₁, C₂, . . . Cₙ,
H₁, H₂, . . . Hₙ,
E₁, E₂, . . . Eₙ]

The first layer following the input layer is the 2D convolutional layer applying a 2D convolution to the n×4 input matrix. The 2D convolution uses a two-dimensions filter of size S×T, where S is lower than n and T is lower than 4. The output of the 2D convolutional layer consists in a resulting matrix:

[A_{1,1}, A_{2,1}, . . . A_{n,1},
A_{1,2}, A_{2,2}, . . . A_{n,2},
A_{1,3}, A_{2,3}, . . . A_{n,3}
A_{1,4}, A_{2,4}, . . . A_{n,4}]

As mentioned previously, the 2D convolutional layer may be followed by a pooling layer for reducing the size of the resulting matrix into a reduced matrix of size P*4 where P is lower than n. Details of the pooling layer are not represented in FIG. 11B for simplification purposes. Various algorithms can be used for implementing the pooling layer, as is well known in the art (a two-dimensions filter of given size is also used by the pooling layer).

The neural network may include several consecutive 2D convolutional layers, optionally respectively followed by pooling layers.

The chain of 2D convolutional layer(s) and optional pooling layer(s) is followed by the one or more fully connected hidden layer, which operate with weights associated to neurons, as is well known in the art.

The usage of one or more 1D convolutional layer (second implementation) allows to detect patterns between the values of the temperature measurements, independently of patterns between the values of the CO2 level measurements, independently of patterns between the values of the humidity level measurements, and independently of patterns between the values of the estimated numbers of persons present in the area.

The usage of one or more 2D convolutional layer (third implementation) allows to detect patterns between the values of the temperature measurements, the values of the CO2 level measurements, the values of the humidity level measurements, and the values of the estimated numbers of persons present in the area.

When using a 2D convolutional layer, the inputs of the neural network usually need to be normalized before processing by the convolutional layer. Normalization consists in adapting the input data (temperature, CO2 level, humidity level, estimated number of persons), so that all input data have the same reference. The input data can then be compared one to the others. Normalization may be implemented in different ways, such as: bringing all input data between 0 and 1, bringing all input data around the mean of each feature (for each input data, subtract the mean and divide by the standard deviation on each feature individually), etc. The effect of normalization is smoothing the image for the 2D convolution and preventing to always take the same feature at the pooling step.

In the case where a convolutional layer is used, parameters of the convolutional layer are also defined and optionally adapted during the training phase. For example, the size of the filter used for the convolution is determined during the training period. The parameters of the convolutional layer are included in the predictive model.

Similarly, in the case where a pooling layer is used, parameters of the pooling layer are also defined and optionally adapted during the training phase. For example, the algorithm and the size of the filter used for the pooling operation are determined during the training period. The parameters of the polling layer are included in the predictive model.

Reference is now made concurrently to FIGS. 1, 2A-B, 5 and 8A-B. The previous description of FIG. 5 with reference to the method 500 also applies to the method 700. The first plurality of environment controllers 100 deployed at the first location implements the method 700 (instead of the method 500). The second plurality of environment controllers 100 deployed at the second location also implements the method 700 (instead of the method 500). FIG. 5 illustrates a decentralized architecture, where the environment controllers 100 take autonomous decisions for controlling the controlled appliances 300, using the predictive model as illustrated in the method 700.

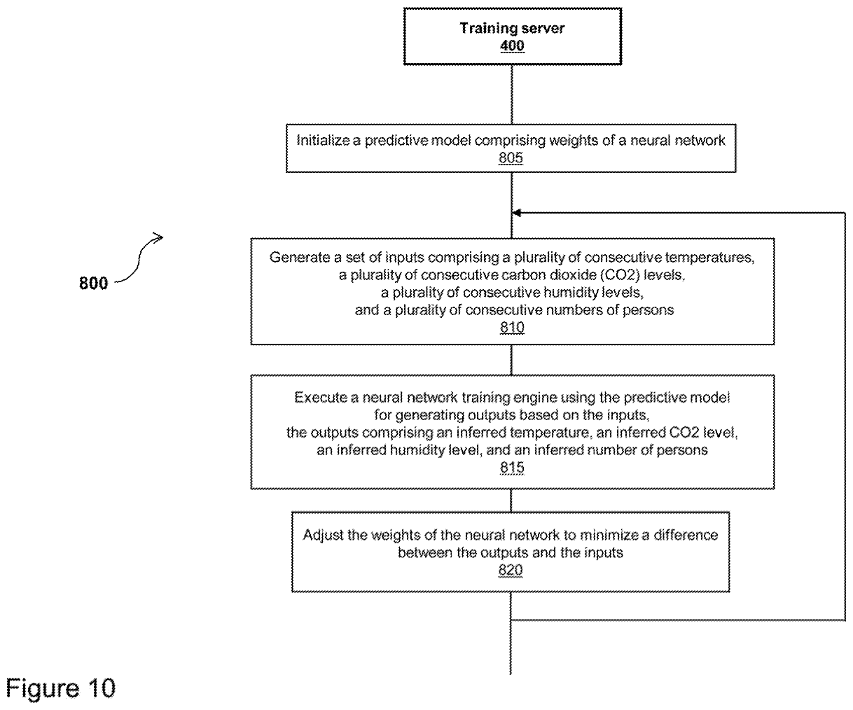

Reference is now made concurrently to FIGS. 1, 6, 7 and 10. FIG. 10 represents a method 800 for training a neural network to validate an estimation of a number of persons present in an area. At least some of the steps of the method 800 represented in FIG. 10 are implemented by the training server 400. The present disclosure is not limited to the method 800 being implemented by the training server 400, but is applicable to any type of computing device capable of implementing the steps of the method 800.

A dedicated computer program has instructions for implementing at least some of the steps of the method 800. The instructions are comprised in a non-transitory computer program product (e.g. the memory 420) of the training server 400. The instructions provide for training a neural network to validate an estimation of a number of persons present in an area, when executed by the processing unit 410 of the training server 400. The instructions are deliverable to the training server 400 via an electronically-readable media such as a storage media (e.g. CD-ROM, USB key, etc.), or via communication links (e.g. via a communication network through the communication interface 430).

As mentioned previously, the instructions of the dedicated computer program executed by the processing unit 410 implement the neural network training engine 411 and the control module 414.

The method 800 comprises the step 805 of initializing a predictive model used by the neural network implemented by the neural network training engine 411. Step 805 is performed by the control module 414 executed by the processing unit 410 of the training server 400. The predictive model comprises the weights of the neural network implemented by the neural network training engine 411. This step is similar to step 605 of the method 600.

As mentioned previously, the initialization of the predictive model comprises defining a number of layers of the neural network, a number of neurons per layer, an initial value for the weights of the neural network, etc. Furthermore, if one or more convolutional (and optionally pooling) layer is used, parameters of the convolutional (and optionally pooling) layer(s) are also defined.

Although not represented in FIG. 10 for simplification purposes, the predictive model initialized at step 805 is stored in the memory 420 of the training server 400.

The method 800 comprises the step 810 of generating a set of inputs comprising a plurality of consecutive temperatures, a plurality of consecutive carbon dioxide (CO2) levels, a plurality of consecutive humidity levels and a plurality of consecutive numbers of persons. Step 810 is performed by the control module 414 executed by the processing unit 410 of the training server 400. This step is similar to step 610 of the method 600, except that for each type of input, a plurality of consecutive values is generated in step 810 instead of a single value in step 610.

The method 800 comprises the step 815 of executing the neural network training engine 411, using the predictive model for generating outputs based on the inputs (generated at step 810). The execution of the neural network training engine 411 is performed by the processing unit 410 of the training server 400. The neural network training engine 411 implements a neural network using the weights of the predictive model. This step is similar to step 615 of the method 600, except for the inputs of the neural network.

The inputs have been defined at step 810. The outputs comprise an inferred temperature, an inferred CO2 level, an inferred humidity level and an inferred number of persons.

The neural network implemented by the neural network training engine 411 corresponds to the neural network implemented by the neural network inference engine 112 (same number of layers, same number of neurons per layer, etc.).

The method 800 comprises the step 820 of adjusting the weights of the neural network to minimize a difference between the outputs (generated at step 815) and the inputs (generated at step 810). Step 820 is performed by the neural network training engine 411 executed by the processing unit 410 of the training server 400. This step is similar to step 620 of the method 600, except that for each type of input, a plurality of consecutive values has been generated at step 810 instead of a single value at step 610.

Although not represented in FIG. 10 for simplification purposes, the modifications to the weights of the neural network performed at step 820 are stored in the memory 420 of the training server 400.

Steps 805, 810, 815 and 820 of the method 800 correspond to step 705 of the method 700 represented in FIG. 8A.

As is well known in the art, steps 810-815-820 are repeated for a plurality of different sets of inputs generated at step 810. The plurality of sets of inputs need to be large enough to properly train the neural network.

At the end of the training phase, the neural network is considered to be properly trained, and the predictive model comprising the final version of the weights is transmitted to the environment controller 100, as illustrated by step 710 of the method 700 represented in FIG. 8A.

A plurality of sets of test inputs is optionally used to validate the accuracy of the predictive model. The sets of test inputs are different from the sets of training inputs used at steps 810-815-820. This procedure well known in the art of neural networks is not represented in FIG. 10 for simplification purposes.

Various techniques well known in the art of neural networks can be used for performing step 820. For example, the adjustment of the weights of the neural network at step 820 uses back propagation. Other techniques, such as the usage of bias in addition to the weights (bias and weights are generally collectively referred to as weights in the neural network terminology), reinforcement training, etc., may also be used.

Furthermore, the evaluation of the difference between the inputs and the outputs of the neural network at step 820 may be implemented in different ways. In a first exemplary implementation, adjusting the weights of the neural network to minimize a difference between the outputs and the inputs comprises adjusting the weights so that the inferred temperature is substantially equal to the last value of the consecutive temperatures, the inferred CO2 level is substantially equal to the last value of the consecutive CO2 levels, the inferred humidity level is substantially equal to the last value of the consecutive humidity levels, and the inferred number of persons is substantially equal to the last value of the consecutive numbers of persons.

In a second exemplary implementation, adjusting the weights of the neural network to minimize a difference between the outputs and the inputs comprises adjusting the weights so that a difference between the inferred temperature and the last value of the consecutive temperatures is within a first tolerance interval, a difference between the inferred CO2 level and the last value of the consecutive CO2 levels is within a second tolerance interval, a difference between the inferred humidity level and the last value of the consecutive humidity levels is within a third tolerance interval, and a difference between the inferred number of persons and the last value of the consecutive numbers of persons is within a fourth tolerance interval.

The collection of the data used for generating the sets of inputs at step 810 may be implemented in different manners. Exemplary implementations of the collection of the data have been provided for the method 600, and are also applicable to the method 800. Furthermore, the order of each temperature in the plurality of consecutive temperatures (used for generating a data set at step 810) is important for the training, and shall correspond to the real experimental conditions when the collection of the data is performed. The same applies for the CO2 levels, humidity levels and numbers of persons.

As mentioned previously, the neural network training engine 411 and the neural network inference engine 112 may be implemented by the same computing device (e.g. the environment controller 100). In this case, the steps of the method 800 and steps 715-755 and 775 of the method 700 (represented in FIGS. 8A and 8B) are performed by the same computing device.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. An environment controller comprising:
memory for storing a predictive model comprising weights of a neural network; and
a processing unit comprising one or more processor configured to:
determine a temperature measurement in an area;
determine a carbon dioxide (CO2) level measurement in the area;
determine a humidity level measurement in the area;
determine an estimated number of persons present in the area based on data generated by an occupancy sensor;
execute a neural network inference engine using the predictive model for generating outputs based on inputs, the inputs comprising the temperature measurement in the area, the CO2 level measurement in the area, the humidity level measurement in the area and the estimated number of persons present in the area, the outputs comprising an inferred temperature, an inferred CO2 level, an inferred humidity level and an inferred number of persons; and
apply a validation algorithm to the inputs and the outputs of the neural network inference engine to determine if the estimated number of persons present in the area is accurate or not.

2. The environment controller of claim 1, wherein the area is a room inside a building.

3. The environment controller of claim 1, wherein determining the temperature measurement in the area consists in receiving the temperature measurement from a temperature sensor located in the area via a communication interface of the environment controller.

4. The environment controller of claim 1, wherein determining the CO2 level measurement in the area consists in receiving the CO2 level measurement from a CO2 sensor located in the area via a communication interface of the environment controller.

5. The environment controller of claim 1, wherein determining the humidity level measurement in the area consists in receiving the humidity level measurement from a humidity sensor located in the area via a communication interface of the environment controller.

6. The environment controller of claim 1, wherein the occupancy sensor comprises one of the following: a visible camera, a thermal camera and an infrared beam sensor.

7. The environment controller of claim 1, wherein the data generated by the occupancy sensor include the estimated number of persons present in the area, and determining the estimated number of persons present in the area based on the data generated by the occupancy sensor consists in directly receiving the estimated number of persons present in the area from the occupancy sensor via a communication interface of the environment controller.

8. The environment controller of claim 1, wherein determining the estimated number of persons present in the area based on the data generated by the occupancy sensor consists in receiving the data generated by the occupancy sensor via a communication interface of the environment controller, and further processing the received data to determine the estimated number of persons present in the area.

9. The environment controller of claim 1, wherein if the validation algorithm determines that the estimated number of persons present in the area is accurate, then the processing unit generates one or more command for controlling a controlled appliance and transmits the one or more command to the controlled appliance via a communication interface of the environment controller, the one or more command being based at least on the estimated number of persons present in the area.

10. The environment controller of claim 1, wherein the controlled appliance consists of a Variable Air Volume (VAV) appliance.

11. The environment controller of claim 1, wherein applying the validation algorithm to the inputs and the outputs of the neural network inference engine comprises performing a comparison of the estimated number of persons and the inferred number of persons.

12. The environment controller of claim 11, wherein the validation algorithm determines that the estimated number of persons present in the area is accurate if the estimated number of persons is substantially equal to the inferred number of persons.

13. The environment controller of claim 11, wherein the validation algorithm determines that the estimated number of persons present in the area is accurate if a difference between the estimated number of persons and the inferred number of persons is within a tolerance interval.

14. The environment controller of claim 1, wherein applying the validation algorithm to the inputs and the outputs of the neural network inference engine comprises performing a comparison of each input among the inputs with the corresponding output among the outputs.

15. The environment controller of claim 14, wherein the validation algorithm determines that the estimated number of persons present in the area is accurate if the inferred temperature is substantially equal to the temperature measurement, the inferred CO2 level is substantially equal to the CO2 level measurement, the inferred humidity level is substantially equal to the humidity level measurement, and the inferred number of persons is substantially equal to the estimated number of persons present in the area.

16. The environment controller of claim 14, wherein the validation algorithm determines that the estimated number of persons present in the area is accurate if a difference between the inferred temperature and the temperature measurement is within a first tolerance interval, a difference between the inferred CO2 level and the CO2 level measurement is within a second tolerance interval, a difference between the inferred humidity level and the humidity level measurement is within a third tolerance interval, and a difference between the inferred number of persons and the estimated number of persons present in the area is within a fourth tolerance interval.

17. The environment controller of claim 1, wherein the neural network inference engine implements the neural network corresponding to the predictive model, the neural network comprising an input layer for receiving the inputs, followed fully connected hidden layers, followed by an output layer for outputting the outputs; the weights of the predictive model being applied to the fully connected hidden layers.

18. A method for validating an estimated number of persons present in an area determined through an occupancy sensor, the method comprising:
storing a predictive model comprising weights of a neural network in a memory of a computing device;
determining by a processing unit of the computing device a temperature measurement in the area;
determining by the processing unit of the computing device a carbon dioxide (CO2) level measurement in the area;
determining by the processing unit of the computing device a humidity level measurement in the area;
determining by the processing unit of the computing device the estimated number of persons present in the area based on data generated by the occupancy sensor;
executing by the processing unit of the computing device a neural network inference engine using the predictive model for generating outputs based on inputs, the inputs comprising the temperature measurement in the area, the CO2 level measurement in the area, the humidity level measurement in the area and the estimated number of persons present in the area, the outputs comprising an inferred temperature, an inferred CO2 level, an inferred humidity level and an inferred number of persons; and
applying by the processing unit of the computing device a validation algorithm to the inputs and the outputs of the neural network inference engine to determine if the estimated number of persons present in the area is accurate or not.

19. A method for training a neural network to validate an estimation of a number of persons present in an area, the method comprising:
(a) initializing by a processing unit of a computing device a predictive model comprising weights of the neural network;
(b) generating by the processing unit of the computing device a set of inputs comprising a reference temperature, a reference carbon dioxide (CO2) level, a reference humidity level and a reference number of persons;
(c) executing by the processing unit of the computing device a neural network training engine using the predictive model for generating outputs based on the inputs, the outputs comprising an inferred temperature, an inferred CO2 level, an inferred humidity level and an inferred number of persons; and
(d) adjusting by the processing unit of the computing device the weights of the neural network to minimize a difference between the outputs and the inputs.

20. The method of claim 19, wherein steps (b), (c) and (d) are repeated for a plurality of sets of inputs.

21. The method of claim 19, wherein the adjustment of the weights of the neural network uses back propagation.

22. The method of claim 19, wherein the neural network training engine implements the neural network corresponding to the predictive model, the neural network comprising an input layer for receiving the inputs, followed by fully connected hidden layers, followed by an output layer for outputting the outputs; the weights of the predictive model being applied to the fully connected hidden layers.

23. The method of claim 19, wherein adjusting the weights of the neural network to minimize a difference between the outputs and the inputs comprises adjusting the weights so that the inferred temperature is substantially equal to the reference temperature, the inferred CO2 level is substantially equal to the reference CO2 level, the inferred humidity level is substantially equal to the reference humidity level, and the inferred number of persons is substantially equal to the reference number of persons.

24. The method of claim 19, wherein adjusting the weights of the neural network to minimize a difference between the outputs and the inputs comprises adjusting the weights so that a difference between the inferred temperature and the reference temperature is within a first tolerance interval, a difference between the inferred CO2 level and the reference CO2 level is within a second tolerance interval, a difference between the inferred humidity level and the reference humidity level is within a third tolerance interval, and a difference between the inferred number of persons and the reference number of persons is within a fourth tolerance interval.

25. An environment controller comprising:
memory for storing a predictive model comprising weights of a neural network; and
a processing unit comprising one or more processor configured to:
determine a plurality of consecutive temperature measurements in an area;
determine a plurality of consecutive carbon dioxide (CO2) level measurements in the area;
determine a plurality of consecutive humidity level measurements in the area;
determine a plurality of consecutive estimated numbers of persons present in the area based on data generated by an occupancy sensor;
execute a neural network inference engine using the predictive model for generating outputs based on inputs, the inputs comprising the plurality of consecutive temperature measurements in the area, the plurality of consecutive CO2 level measurements in the area, the plurality of consecutive humidity level measurements in the area and the plurality of consecutive estimated numbers of persons present in the area, the outputs comprising an inferred temperature, an inferred CO2 level, an inferred humidity level and an inferred number of persons; and
apply a validation algorithm to the inputs and the outputs of the neural network inference engine to determine if a candidate number of persons present in the area is accurate or not, the candidate number of persons present in the area consisting of the last value of the plurality of consecutive estimated numbers of persons present in the area.

26. The environment controller of claim 25, wherein the area is a room inside a building.

27. The environment controller of claim 25, wherein determining the plurality of consecutive temperature measurements in the area consists in receiving the plurality of consecutive temperature measurements from a temperature sensor located in the area via a communication interface of the environment controller.

28. The environment controller of claim 25, wherein determining the plurality of consecutive CO2 level measurements in the area consists in receiving the plurality of consecutive CO2 level measurements from a CO2 sensor located in the area via a communication interface of the environment controller.

29. The environment controller of claim 25, wherein determining the plurality of consecutive humidity level measurements in the area consists in receiving the plurality of consecutive humidity level measurements from a humidity sensor located in the area via a communication interface of the environment controller.

30. The environment controller of claim 25, wherein the occupancy sensor comprises one of the following: a visible camera, a thermal camera and an infrared beam sensor.

31. The environment controller of claim 25, wherein the data generated by the occupancy sensor include the plurality of consecutive estimated numbers of persons present in the area, and determining the plurality of consecutive estimated numbers of persons present in the area based on the data generated by the occupancy sensor consists in directly receiving the plurality of consecutive estimated numbers of persons present in the area from the occupancy sensor via a communication interface of the environment controller.

32. The environment controller of claim 25, wherein determining the plurality of consecutive estimated numbers of persons present in the area based on the data generated by the occupancy sensor consists in receiving the data generated by the occupancy sensor via a communication interface of the environment controller, and further processing the received data to determine the plurality of consecutive estimated numbers of persons present in the area.

33. The environment controller of claim 25, wherein if the validation algorithm determines that the candidate number of persons present in the area is accurate, then the processing unit generates one or more command for controlling a controlled appliance and transmits the one or more command to the controlled appliance via a communication interface of the environment controller, the one or more command being based at least on the candidate number of persons present in the area.

34. The environment controller of claim 33, wherein the controlled appliance consists of a Variable Air Volume (VAV) appliance.

35. The environment controller of claim 25, wherein applying the validation algorithm to the inputs and the outputs of the neural network inference engine comprises performing a comparison of the candidate number of persons present in the area and the inferred number of persons.

36. The environment controller of claim 35, wherein the validation algorithm determines that the candidate number of persons present in the area is accurate if the candidate number of persons is substantially equal to the inferred number of persons.

37. The environment controller of claim 35, wherein the validation algorithm determines that the candidate number of persons present in the area is accurate if a difference between the candidate number of persons and the inferred number of persons is within a tolerance interval.

38. The environment controller of claim 25, wherein the validation algorithm determines that the candidate number of persons present in the area is accurate if the inferred temperature is substantially equal to the last value of the plurality of consecutive temperature measurements, the inferred CO2 level is substantially equal to the last value of the plurality of consecutive CO2 level measurements, the inferred humidity level is substantially equal to the last value of the plurality of consecutive humidity level measurements, and the inferred number of persons is substantially equal to the candidate number of persons.

39. The environment controller of claim 25, wherein the validation algorithm determines that the candidate number of persons present in the area is accurate if a difference between the inferred temperature and the last value of the plurality of consecutive temperature measurements is within a first tolerance interval, a difference between the inferred CO2 level and the last value of the plurality of consecutive CO2 level measurements is within a second tolerance interval, a difference between the inferred humidity level and the last value of the plurality of consecutive humidity level measurements is within a third tolerance interval, and a difference between the inferred number of persons and the candidate number of persons is within a fourth tolerance interval.

40. The environment controller of claim 25, wherein the neural network inference engine implements the neural network corresponding to the predictive model, the neural network comprising an input layer for receiving the inputs, followed by fully connected hidden layers, followed by an output layer for outputting the outputs; the weights of the predictive model being applied to the fully connected hidden layers.

41. The environment controller of claim 25, wherein the neural network inference engine implements the neural network corresponding to the predictive model, the neural network comprising one input layer, followed by at least one one-dimensional convolutional layer, followed by fully connected hidden layers, followed by an output layer; the input layer receiving four one-dimension matrices, each one-dimension matrix respectively comprising the plurality of consecutive temperature measurements in the area, the plurality of consecutive CO2 level measurements in the area, the plurality of consecutive humidity level measurements in the area and the plurality of consecutive estimated numbers of persons present in the area; the at least one one-dimensional convolutional layer applying a one-dimensional convolution to each one-dimension matrix; the output layer outputting the outputs; the weights of the predictive model being applied to the fully connected hidden layers and the predictive model further comprising parameters for the at least one one-dimensional convolutional layer.

42. The environment controller of claim 41, wherein the neural network further comprises at least one pooling layer.

43. The environment controller of claim 25, wherein the neural network inference engine implements the neural network corresponding to the predictive model, the neural network comprising one input layer, followed by at least one two-dimensional convolutional layer, followed by fully connected hidden layers, followed by an output layer; the input layer receiving a two-dimensions matrix comprising the plurality of consecutive temperature measurements in the area, the plurality of consecutive CO2 level measurements in the area, the plurality of consecutive humidity level measurements in the area and the plurality of consecutive estimated numbers of persons present in the area; the at least one two-dimensional convolutional layer applying a two-dimensional convolution to the two-dimensions matrix; the output layer outputting the outputs; the weights of the predictive model being applied to the fully connected hidden layers and the predictive model further comprising parameters for the at least one two-dimensional convolutional layer.

44. The environment controller of claim 43, wherein the neural network further comprises at least one pooling layer.

45. A method for validating a candidate number of persons present in an area determined through an occupancy sensor, the method comprising:
storing a predictive model comprising weights of a neural network in a memory of a computing device;
determining by a processing unit of the computing device a plurality of consecutive temperature measurements in the area;
determining by the processing unit of the computing device a plurality of consecutive carbon dioxide (CO2) level measurements in the area;
determining by the processing unit of the computing device a plurality of consecutive humidity level measurements in the area;
determining by the processing unit of the computing device a plurality of consecutive estimated numbers of persons present in the area based on data generated by the occupancy sensor;
executing by the processing unit of the computing device a neural network inference engine using the predictive model for generating outputs based on inputs, the inputs comprising the plurality of consecutive temperature measurements in the area, the plurality of consecutive CO2 level measurements in the area, the plurality of consecutive humidity level measurements in the area and the plurality of consecutive estimated numbers of persons present in the area, the outputs comprising an inferred temperature, an inferred CO2 level, an inferred humidity level and an inferred number of persons; and
applying by the processing unit of the computing device a validation algorithm to the inputs and the outputs of the neural network inference engine to determine if the candidate number of persons present in the area is accurate or not, the candidate number of persons present in the area consisting of the last value of the plurality of consecutive estimated numbers of persons present in the area.

46. A method for training a neural network to validate an estimation of a number of persons present in an area, the method comprising:
(a) initializing by a processing unit of a computing device a predictive model comprising weights of the neural network;
(b) generating by the processing unit of the computing device a set of inputs comprising a plurality of consecutive temperatures, a plurality of consecutive carbon dioxide (CO2) levels, a plurality of consecutive humidity levels and a plurality of consecutive numbers of persons;
(c) executing by the processing unit of the computing device a neural network training engine using the predictive model for generating outputs based on the inputs, the outputs comprising an inferred temperature, an inferred CO2 level, an inferred humidity level and an inferred number of persons; and
(d) adjusting by the processing unit of the computing device the weights of the neural network to minimize a difference between the outputs and the inputs.

47. The method of claim 46, wherein steps (b), (c) and (d) are repeated for a plurality of sets of inputs.

48. The method of claim 46, wherein the adjustment of the weights of the neural network uses back propagation.

49. The method of claim 46, wherein the neural network training engine implements the neural network corresponding to the predictive model, the neural network comprising an input layer for receiving the inputs, followed by fully connected hidden layers, followed by an output layer for outputting the outputs; the weights of the predictive model being applied to the fully connected hidden layers.

50. The method of claim 46, wherein the neural network training engine implements the neural network corresponding to the predictive model, the neural network comprising one input layer, followed by at least one one-dimensional convolutional layer, followed by fully connected hidden layers, followed by an output layer; the input layer receiving four one-dimension matrices, each one-dimension matrix respectively comprising the plurality of consecutive temperatures, the plurality of consecutive CO2 levels, the plurality of consecutive humidity levels and the plurality of consecutive numbers of persons; the at least one one-dimensional convolutional layer applying a one-dimensional convolution to each one-dimension matrix; the output layer outputting the outputs; the weights of the predictive model being applied to the fully connected hidden layers and the predictive model further comprising parameters for the at least one one-dimensional convolutional layer.

51. The method of claim 50, wherein the neural network further comprises at least one pooling layer.

52. The method of claim 46, wherein the neural network inference engine implements the neural network corresponding to the predictive model, the neural network comprising one input layer, followed by at least one two-dimensional convolutional layer, followed by fully connected hidden layers, followed by an output layer; the input layer receiving a two-dimensions matrix comprising the plurality of consecutive temperatures, the plurality of consecutive CO2 levels, the plurality of consecutive humidity levels and the plurality of consecutive numbers of persons; the at least one two-dimensional convolutional layer applying a two-dimensional convolution to the two-dimensions matrix; the output layer outputting the outputs; the weights of the predictive model being applied to the fully connected hidden layers and the predictive model further comprising parameters for the at least one two-dimensional convolutional layer.

53. The method of claim 52, wherein the neural network further comprises at least one pooling layer.

54. The method of claim 46, wherein adjusting the weights of the neural network to minimize a difference between the outputs and the inputs comprises adjusting the weights so that the inferred temperature is substantially equal to the last value of the plurality of consecutive temperatures, the inferred CO2 level is substantially equal to the last value of the plurality of consecutive CO2 levels, the inferred humidity level is substantially equal to the last value of the plurality of consecutive humidity levels, and the inferred number of persons is substantially equal to the last value of the plurality of consecutive numbers of persons.

55. The method of claim 46, wherein adjusting the weights of the neural network to minimize a difference between the outputs and the inputs comprises adjusting the weights so that a difference between the inferred temperature and the last value of the plurality of consecutive temperatures is within a first tolerance interval, a difference between the inferred CO2 level and the last value of the plurality of consecutive CO2 levels is within a second tolerance interval, a difference between the inferred humidity level and the last value of the plurality of consecutive humidity levels is within a third tolerance interval, and a difference between the inferred number of persons and the last value of the plurality of consecutive numbers of persons is within a fourth tolerance interval.
